(19) United States
(12) Patent Application Publication
(10) Pub. No.: US 2026/0119414 A1
(43) Pub. Date: Apr. 30, 2026

(54) Intelligent Compression of Data Configured for Access via Computer Express Link Fabric

(71) Applicant: Micron Technology, Inc., Boise, ID (US)

(72) Inventors: Kamil Khan, Folsom, CA (US); Saideep Tiku, Folsom, CA (US); Poorna Kale, Folsom, CA (US)

(21) Appl. No.: 18/931,615

(22) Filed: Oct. 30, 2024

(51) Int. Cl. G06F 13/16

(52) U.S. Cl. CPC G06F 13/16; G06F 2213/0026

(57) ABSTRACT

A method to manage a computer express link fabric, including: routing, through the computer express link fabric, memory access requests to one or more memory devices connected to the computer express link fabric to generate responses to the memory access requests; updating, using a reinforcement learning technique and based on the routing, expected reward values for compressing a portion of data stored in the one or more memory devices using a plurality of compression techniques; selecting, based on the expected reward values, a compression technique from the plurality of compression techniques; and performing compression of the portion of the data using the compression technique selected based on the expected reward values.

### TECHNICAL FIELD

At least some embodiments disclosed herein relate to memory systems in general, and more particularly, but not limited to memory access over a computer express link fabric.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 to FIG. 4 show techniques to provide a host memory buffer to a memory sub-system according to some embodiments.

FIG. 5 and FIG. 6 show dynamic mapping of host memory buffers to memory devices on a computer express link (CXL) fabric according to one embodiment.

FIG. 7 shows a technique to access a memory sub-system using a memory space provided via a computer express link fabric according to one embodiment.

FIG. 8 illustrates execution of a storage access command according to one embodiment.

FIG. 9 illustrates a controller of a computer express link (CXL) fabric caching portions of memory sub-systems in the memory space provided by memory devices connected to the fabric according to one embodiment.

FIG. 10 illustrates communications to implement a memory access request according to one embodiment.

FIG. 11 to FIG. 13 show methods to provide memory access to a storage space of a memory sub-system according to some embodiments.

FIG. 14 shows a method to implement a disaggregated host memory buffer via random access memory connected via a computer express link fabric according to one embodiment.

FIG. 15 shows a method to implement storage services via a memory sub-system having a computer express link connection to access random access memory cells connected via a computer express link fabric according to one embodiment.

FIG. 16 shows a method to provide unified memory and storage services over computer express link fabric according to one embodiment.

FIG. 17 shows a computer express link fabric configured to manage routing of memory access requests and data placement with compression using reinforcement learning according to one embodiment.

FIG. 18 shows a controller of a computer express link fabric according to one embodiment.

FIG. 19 shows a computer express link fabric switch according to one embodiment.

FIG. 20 shows a reinforcement learning module configured to optimize mapping from a mapped memory space to random access memories in memory devices connected to a computer express link fabric according to one embodiment.

FIG. 21 shows a reinforcement learning module configured to optimize mapping from a mapped memory space to random access memories in memory devices and to storage spaces in memory sub-systems connected to a computer express link fabric according to one embodiment.

FIG. 22 and FIG. 23 show a reinforcement learning agent configured in a computer express link switch to optimize routing of memory access requests and memory mapping according to one embodiment.

FIG. 24 shows a method to manage compression of data accessible via a computer express link fabric according to one embodiment.

FIG. 25 shows a method of predictive decompression of data for access via a computer express link fabric according to one embodiment.

FIG. 26 is a block diagram of an example computer system in which embodiments of the present disclosure can operate.

### DETAILED DESCRIPTION

At least some aspects of the present disclosure are directed to the provision of host memory buffers to memory sub-systems (e.g., solid-state drives (SSDs)) via computer express links (CXLs).

A typical solid-state drive (SSD) is configured to use a non-volatile memory (e.g., NAND memory) as its persistent storage medium. Locations in the persistent storage medium can be identified or addressed by a host system using logical block addressing (LBA) addresses. A flash translation layer of the solid-state drive can translate the LBA addresses, used by a host system in identifying locations in the persistent storage medium, into internal physical addresses of corresponding locations in the non-volatile memory to perform operations of retrieving data and storing data. Such address translation operations are typically performed using a logical to physical translation table.

Such a solid-state drive (SSD) is typically configured to use a portion of its persistent storage medium (e.g., NAND memory) for persistent storage of the logical to physical translation table as part of metadata. In addition to the relatively slow persistent storage medium, the solid-state drive can have an amount of fast random access memory (e.g., dynamic random access memory (DRAM) or static random access memory (SRAM)). The fast random access memory can be used to temporarily store data used in computations performed for various operations of the solid-state drive, such as address translations. For example, an actively used portion of the logical to physical translation table can be loaded into the random access memory for caching or buffering, such that the address translations performed using the active portion can be accelerated.

However, the amount of random access memory configured in a solid-state drive (SSD) is typically insufficient to hold the entire logical to physical translation table. When the storage capacities of solid-state drives increase, the sizes of their logical to physical translation tables also increase.

A host memory buffer (HMB) is a buffer allocated to a storage device (e.g., solid-state drive (SSD)) from the memory of the host system. When a host memory buffer is allocated to a solid-state drive, the solid-state drive can buffer at least a portion of its logical to physical translation table externally in the host memory buffer to improve its performance. Accessing the external host memory buffer can be faster than accessing the internal persistent storage medium (e.g., NAND memory).

However, a typical host system has a limited amount of main memory connected to its memory bus (e.g., a double data rate (DDR) bus). To scale up the storage capacity of the computing system, many solid-state drives can be attached to a host system. However, allocating host memory buffers from the main memory to the many solid-state drives can degrade the performance of the host system.

At least some aspects of the present disclosure address the above and other deficiencies and challenges by providing host memory buffers via a computer express link (CXL) fabric.

A computer express link (CXL) fabric can have one or more CXL switches connecting a plurality of point to point CXL connections. A set of memory devices can be connected to the CXL fabric to provide a unified address space of random access memory. Memory addresses in the unified address space can be mapped to the random access memory cells in the memory devices. Requests to access memory addresses in the unified address space can propagate through the CXL fabric to the mapped random access memory cells in the memory devices connected to the CXL fabric. The random access memory implemented via the CXL fabric and the memory devices as a whole can be accessed, with cache coherence, by multiple hosts or computing devices (e.g., a central processing unit (CPU), a graphics processing unit (GPU), an artificial intelligence (AI) accelerator). The capacity of the random access memory can increase via connecting more memory devices to the CXL fabric.

A portion of the random access memory, provided via the CXL fabric and its connected memory devices as a whole, can be allocated as host memory buffers to memory sub-systems (e.g., solid-state drives). Thus, the main memory connected to a processing device (e.g., central processing unit (CPU) or system on a chip (SoC)) via a memory bus (e.g., double data rate (DDR) bus) can be reserved for the processing device for improved system performance, as further discussed below.

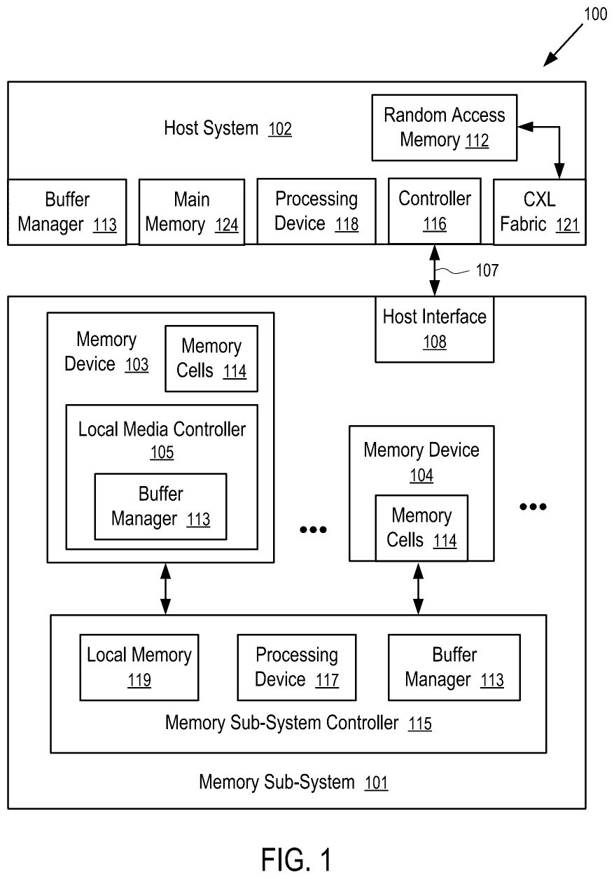

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a buffer manager 113 configured to perform operations related to the management of buffers allocated to submission queues through which commands are provided from the host system 102 to the memory sub-system 101 for execution. In some embodiments, the controller 115 in the memory sub-system 101 includes at least a portion of the buffer manager 113. In other embodiments, or in combination, the controller 116 and/or the processing device 118 in the host system 102 includes at least a portion of the buffer manager 113. For example, the controller 115, the controller 116, and/or the processing device 118 can include logic circuitry implementing the buffer manager 113. For example, the controller 115, or the processing device 118 (processor) of the host system 102, can be configured to execute instructions stored in memory for performing the operations of the buffer manager 113 described herein. In some embodiments, the buffer manager 113 is implemented in an integrated circuit chip disposed in the memory sub-system 101. In other embodiments, the buffer manager 113 can be part of firmware of the memory sub-system 101, an operating system of the host system 102, a device driver, or an application, or any combination therein.

For example, the buffer manager 113 implemented in the controller 115 and/or 105 of the memory sub-system 101 and/or the host system 102 can be configured to perform operations to allocate and manage a portion of a random access memory 112 provided as a host memory buffer (HMB) over a computer express link (CXL) fabric 121 to the memory sub-system 101, as further discussed below.

For example, the computer express link (CXL) fabric 121 can have one or more CXL switches connected to a plurality of memory devices to provide the random access memory 112. A host memory buffer allocated from the random access memory 112 to the memory sub-system can be disaggregated across the plurality of memory devices over the CXL fabric 121.

Memory devices connected to the CXL fabric 121 can provide a memory space addressable by a host (e.g., processing device 118, such as a central processing unit (CPU) or system on a chip (SoC)). Such a memory space of random access memory 112 provided via the CXL fabric 121 can have advantages in flexibility and scalability, when compared with the memory space of the main memory 124 provided over a memory bus (e.g., a double data rate (DDR) bus connected between the main memory 124 and the processing device 118).

Instead of configuring a host memory buffer (HMB) in the main memory 124, the host system 102 connected to the memory sub-system 101 can allocate (e.g., at the boot time) a portion of the random access memory 112 provided via the CXL fabric 121 to the memory sub-system 101 (e.g., a solid-state drive) as a host memory buffer (HMB). The memory sub-system 101 can use the host memory buffer (HMB) to store a logical to physical translation table used in the operations of its flash translation layer.

The computer express link (CXL) fabric 121 can be used to implement the host memory buffer (HMB) across a plurality of physical/logical memory devices over the CXL fabric 121. For example, a controller in the CXL fabric 121 can be configured to dynamically map the portion of random access memory 112, allocated by the host system 102 to implement the host memory buffer (HMB) for the memory sub-system 101, to physical memory cells in multiple memory devices connected to the CXL fabric 121. Thus, different portions of the host memory buffer (HMB) can physically reside in different memory devices connected to the computer express link (CXL) fabric 121. The controller can dynamically adjust the mapping based on traffic and usage in the fabric 121 to improve performance.

The flexibility and scalability of the random access memory 112 provided via the CXL fabric 121 can easily accommodate the growing demand for the size/capacity of host memory buffers allocated to multiple memory sub-systems that may be connected to the host system 102. When more memory sub-systems (e.g., 101) are connected to the host system 102, the host system 102 can allocate additional portions from the same random access memory 112, provided via the CXL fabric 121, to the memory sub-systems (e.g., 101) being added to improve their performance in logical to physical translations.

In some implementations, a disaggregated memory allocated from the random access memory 112 is connected to the memory sub-system 101 over the CXL fabric 121 to further support storage services of the memory sub-system 101, in addition to logical to physical address translations.

For example, the memory sub-system 101 can be connected to the CXL fabric 121 (e.g., as one of hosts of the CXL fabric 121) to access at least a portion of the random access memory 112 for its operations, such as storing a portion of the logical to physical translation table used in the operations of the flash translation layer of the memory sub-system 101. The memory sub-system 101 can use the portion of the random access memory 112 in a way similar to the use of its local memory 119, as if the portion of the random access memory were built into the memory sub-system 101. For example, the connection 107 can include a CXL connection to the CXL fabric 121. For example, the processing device 118 (e.g., a CPU, GPU, or SoC) can access both the random access memory 112 and the storage space of the memory sub-system 101 over the CXL fabric 121. Thus, host management of the memory sub-system 101 can be simplified.

For example, using a CXL protocol the memory sub-system 101 can use a portion of the random access memory 112 across a plurality of physical/logical memory devices in the operations of the memory sub-system 101. A controller in the CXL fabric 121 can be configured to dynamically map the portion of random access memory 112 used by the memory sub-system to the physical addresses in the memory devices connected to the CXL fabric 121. The controller can adjust the mapping based on traffic and usage of connections in the fabric 121 for improve performance.

Since the memory sub-system 101 can use a portion of the random access memory 112 over the fabric 121, the amount of local memory 119 built into the memory sub-system 101 for its exclusive use can be reduced. The flexibility and scalability of the random access memory 112 provided via the CXL fabric 121 allow the random access memory 112 to be shared among multiple memory sub-systems (e.g., 101) and the processing device 118 for improved utilization. As the demand for the random access memory 112 increases, more memory devices and/or CXL switches can be added to the fabric 121 to accommodate the growing demand of the computing system 100.

In some implementations, a controller of the CXL fabric 121 can be configured to use the random access memory 112 and the memory sub-system 101 to provide unified memory and storage services to the processing device 118 (e.g., a CPU, GPU, or SoC) in the host system 102 over the CXL fabric 121.

For example, a controller of the CXL fabric 121 can be configured to integrate the memory services of the memory devices providing the random access memory 112 and the storage services of the memory sub-system 101 to provide a unified memory space of random access memory that has a capacity larger than the capacity of the random access memory 112 and that has a persistent storage capability. Based on the data sizes addressed by the processing device 118, the controller of the fabric 121 can dynamically switch between directing the requests to the memory sub-system 115 and directing to the random access memory 112. Further, the controller of the fabric 121 can dynamically allocate a portion of the random access memory 112 as a cache memory for accessing an active portion of the storage space of the memory sub-system 101, such that the storage space of the memory sub-system 101 can appear to the processing device 118 as a portion of random access memory accessible via the fabric 121.

For example, the memory sub-system 101 can be configured to protect data stored in its persistent storage medium (e.g., non-volatile memory cells 114, such as NAND memory cells) using an error correction code (ECC) technique. An ECC block size (e.g., 512 bytes or larger) of the memory sub-system 101 can be significantly larger than a typical memory access size (e.g., a cache line of 128 bytes or smaller). When the processing device 118 in the host system 102 accesses data at a small chunk size and the data being accessed is in the memory sub-system 101, the controller of the fabric 121 can take the ECC decoded/corrected data and mirror it in a portion of the random access memory 112 device for subsequent access. The controller 116 can dynamically remap the address as accessed by the processing device 118 from the memory sub-system 101 to the random access memory 112 for the block. When the processing device 118 accesses data at a large chunk size, the controller can map the address back to the storage space in the memory sub-system 101, as further discussed below.

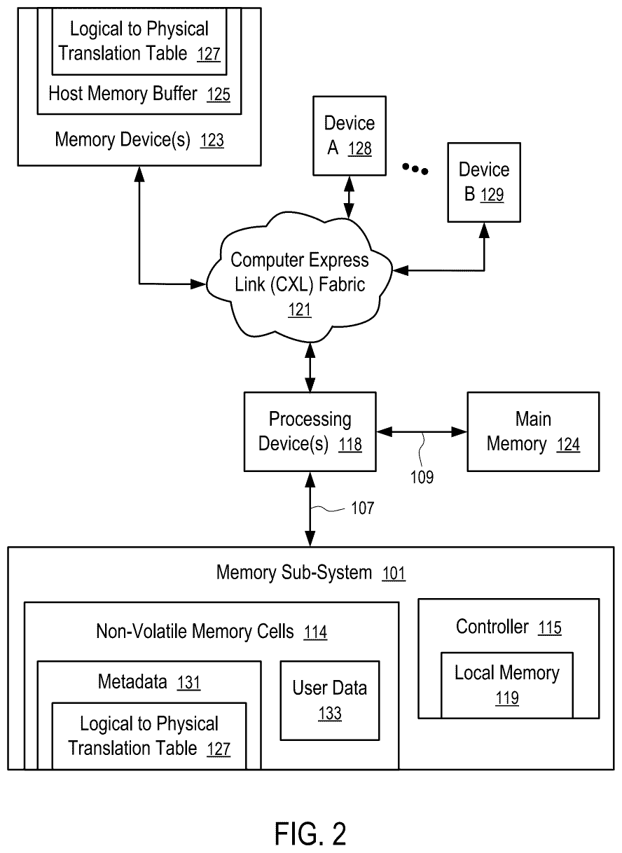

FIG. 2 to FIG. 4 show techniques to provide a host memory buffer to a memory sub-system according to some embodiments. For example, the techniques of FIG. 2 to FIG. 4 can be implemented in the computing system 100 of FIG. 1 using the random access memory 112 provided over the CXL fabric 121.

In FIG. 2 to FIG. 4, a computer express link (CXL) fabric 121 is configured to provide a unified memory space of random access memory (e.g., 112) using a set of memory devices 123 that have random access memory cells.

For example, the computer express link (CXL) fabric 121 can include a set of switches interconnected via CXL connections and controlled at least in part by a controller. The memory devices 123 are connected to the switches in the fabric 121 via point to point CXL connections; and the controller of the CXL fabric 121 is configured to direct how memory access communications are routed by the switches through the fabric 121 to the memory devices 123.

The unified memory space of random access memory (e.g., 112), implemented using the memory devices 123 connected via the fabric 121, can service multiple hosts/processing devices, such as processing device(s) 118 (e.g., central processing unit (CPU), system on a chip (SoC)), and other devices 128, . . . , 129 (e.g., artificial intelligence (AI) accelerator, graphical processing unit (GPU), network interface card).

In FIG. 2, a main memory 124 is connected to the processing device(s) 118 via a memory bus 109 (e.g., a double data rate (DDR) bus); and a memory sub-system 101 (e.g., as in FIG. 1) is connected to the processing device(s) using a peripheral bus 107 (e.g., a peripheral component interconnect express (PCIe) bus) that is different and separate from the memory bus 109.

The memory of the host system 102 as a whole can include the main memory 124 and the unified memory space of random access memory (e.g., 112) implemented using the memory devices 123 connected via the fabric 121.

In FIG. 2, instead of allocating a host memory buffer (HMB) from the main memory 124 to memory sub-system 101, a host memory buffer 125 is allocated (e.g., by a buffer manager 113) to the memory sub-system 101 from the random access memory of the memory devices 123.

For example, the memory sub-system 101 can use its non-volatile memory cells 114 (e.g., NAND memory) for persistent storage of metadata 131, such as a logical to physical translation table 127. The storage capacity of the memory cells 114 is used to store both user data 133 and the metadata 131 about the storage of the user data 133.

However, accessing the non-volatile memory cells 114 for address translation computations can be slower than accessing the host memory buffer 125 over the CXL fabric 121 and slower than accessing the local memory 119.

To improve the speed of address translation operations, the buffer manager 113 in the memory sub-system 101 can load an actively used portion of the logical to physical translation table 127 into its local memory 119, and load another portion of the logical to physical translation table 127 that is likely to be used into the host memory buffer 125. Such an arrangement can reduce the need to read and write the non-volatile memory cells 114 to use and update the logical physical translation table 127 and thus improve the overall performance of the memory sub-system 101 in providing its storage services. Optionally, the memory sub-system 101 can use a portion of the logical to physical translation table 127 in the host memory buffer 125 directly in address translation without loading the portion into the local memory 119.

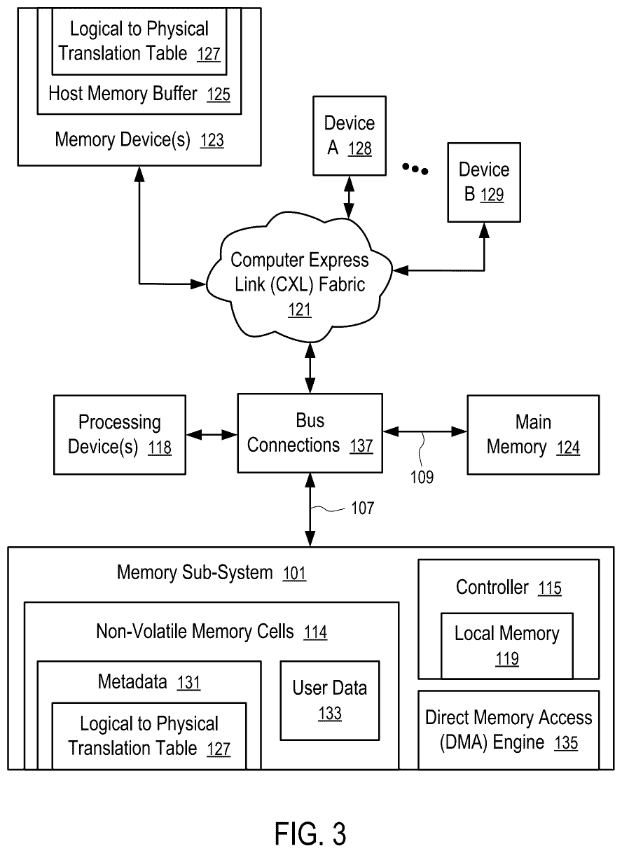

In some implementations, the memory sub-system 101 can access, over the CXL fabric 121, the host memory buffer 125 in the memory devices 123 without going through and/or without assistance from the processing devices 118 connected to the main memory 124, as in FIG. 3

In FIG. 3, a set of bus connections 137 can interconnect the peripheral bus 107 (e.g., a peripheral component interconnect express (PCIe) bus), the memory bus 109 (e.g., a double data rate (DDR) bus) and the CXL fabric 121. The memory sub-system 101 is configured with a direct memory access (DMA) engine 135 operable to access the memory in the host system 102, including the main memory 124 and the unified memory space of random access memory (e.g., 112) implemented using the memory devices 123 connected via the fabric 121.

Using the DMA engine 135 the buffer manager 113 of the memory sub-system 101 can copy a portion of the logical physical translation table 127 from the local memory 119 to the host memory buffer 125 in the memory devices 123. Thus, the local memory 119 can be freed for storing another portion of the logical to physical translation table 127 for active use, or for other memory usages.

For example, the memory sub-system 101 can retrieve a portion of the logical to physical translation table 127 from the non-volatile memory cells 114 into the local memory 119 and then copy the portion to the host memory buffer 125 (e.g., for buffering/caching, and/or for reference in address translation).

For example, the memory sub-system 101 can store a portion of the logical to physical translation table 127 in the local memory 119 for active address translation operations. When subsequent operations do not use the portion for a period of time, the memory sub-system 101 can offload the portion to the host memory buffer 125 for buffering and to load another portion of the logical to physical translation table 127 (e.g., from the host memory buffer 125, or the memory cells 114) for active use.

When a portion of the logical physical translation table 127 in the host memory buffer 125 is to be used actively, the DMA engine 135 can fetch the portion of the logical physical translation table 127 from the host memory buffer 125 into the local memory 119 without assistance from the processing device(s) 118.

In some implementations, the DMA engine 135 and/or the memory sub-system 101 can function as a host of the main memory 124 and/or the unified memory space of random access memory (e.g., 112) implemented using the memory devices 123 connected via the fabric 121. Thus, the memory sub-system 101 can configure a portion of the local memory 119 as a cache memory for accessing the unified memory space of random access memory (e.g., 112) implemented using the memory devices 123 connected to the fabric 121, including the host memory buffer 125.

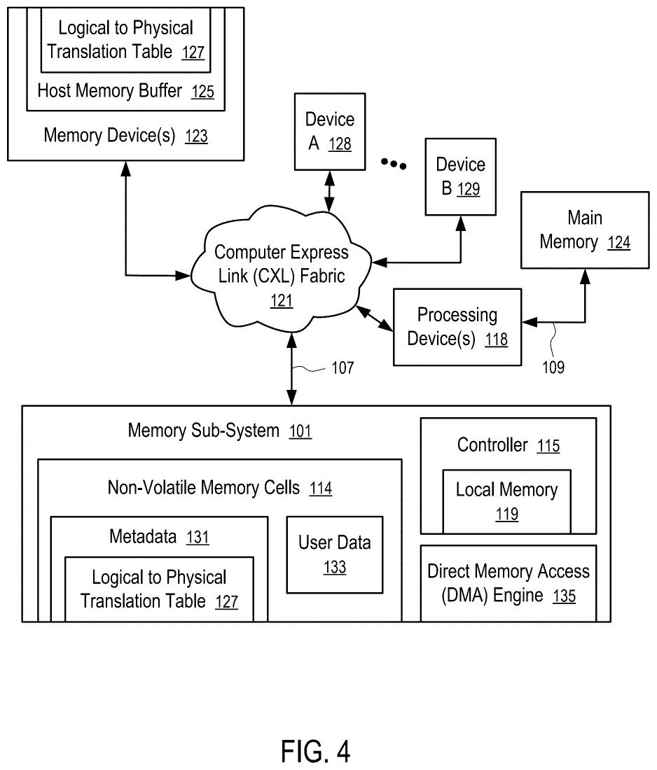

In some implementations, the connection 107 to the memory sub-system 101 is also a computer express link (CXL) connection to the fabric 121, as in FIG. 4.

When the memory sub-system 101 is connected to the fabric 121 via a computer express link (CXL) connection, the memory sub-system 101 and/or a direct memory access (DMA) engine in the memory sub-system 101 can use the unified memory space of random access memory (e.g., 112) implemented using the memory devices 123 connected via the fabric 121 in a way similar to the processing device(s) 118 using the unified memory space of random access memory (e.g., 112). The memory sub-system 101 can dynamically allocate a portion of the unified memory space as its host memory buffer 125 to store the entire logical to physical translation table 127 or a portion of it, without assistance from the processing device(s) 118 connected to the main memory 124.

In some implementations, when the memory sub-system 101 is connected to the fabric 121 via a computer express link (CXL) connection, a controller of the CXL fabric 121 can use the storage space of the non-volatile memory cells 114 to provide a logical memory device in a portion of the unified memory space of random access memory accessible by various hosts connected to the fabric 121, such as the processing device(s) 118 and other devices 128, . . . , 129 (e.g., artificial intelligence (AI) accelerator, graphical processing unit (GPU)), as further discussed below. Thus, the devices (e.g., 118, 128, 129) connected to the fabric 121 can virtually access the memory sub-system 101 over the fabric 121 as if the storage space of the memory sub-system 101 (e.g., the capacity of the non-volatile memory cells 114) were random access memory.

Different portions of the capacity of a storage device (e.g., solid-state drive) is typically configured to be addressed for access using logical block addressing (LBA) addresses. Each LBA address represents a predetermined amount of capacity (e.g., 512 bytes, 4 KB), which is significantly larger than the capacity represented by a memory address for accessing a random access memory.

Different portions of a random access memory (e.g., 124, 112) is typically configured to be addressed for access using memory addresses. Each memory address represents a predetermined amount of capacity (e.g., one byte, eight bytes, or 128 bytes), which is significantly smaller than the capacity of an LBA address for accessing a storage device.

Communication protocols for accessing via LBA addresses and for accessing via memory addresses are typically adapted differently to accommodate typical patterns of accessing: large chunks of data accessed via LBA addresses and small chunks of data accessed via memory addresses.

For example, when a large chunk of data is accessed via an LBA address, it is possible to use a relatively large amount of communication overhead to implement enhanced features without significantly degrading the system performance. In contrast, when a small chunk of data is accessed via a memory address, an increase in communication overhead can significantly degrade the system performance. Thus, block-based storage devices and random access memory devices are typically not interchangeable in their usages in a computing system.

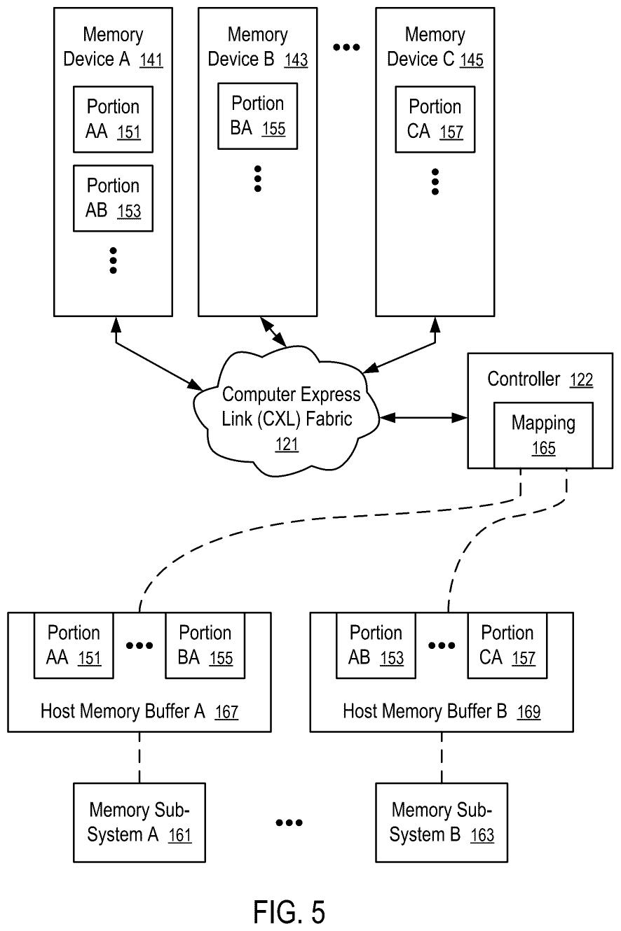

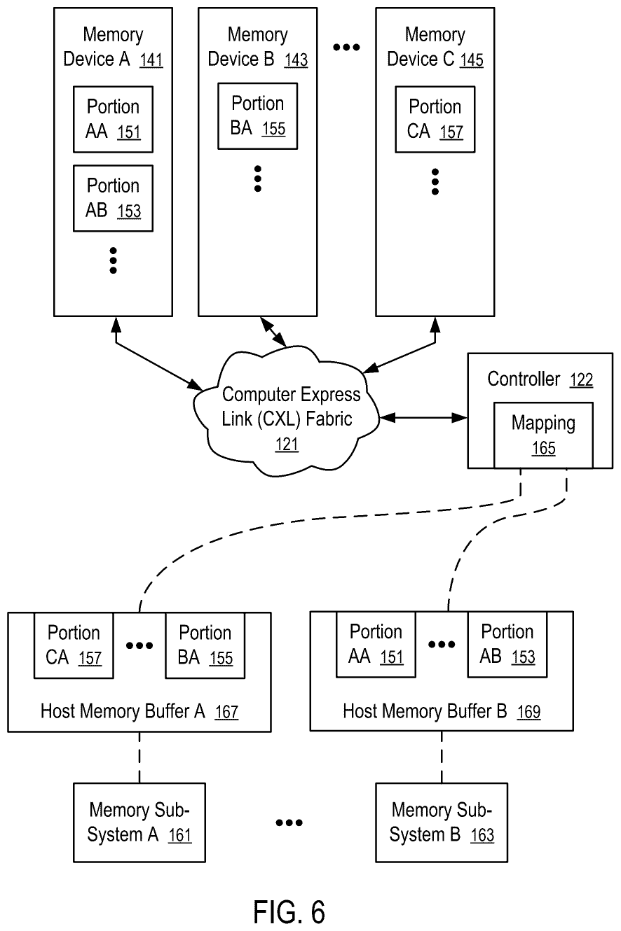

FIG. 5 and FIG. 6 show dynamic mapping of host memory buffers to memory devices on a computer express link (CXL) fabric according to one embodiment. For example, the host memory buffer 125 in FIG. 2 to FIG. 4 can be mapped dynamically in a way as illustrated in FIG. 5 and FIG. 6.

In FIG. 5 and FIG. 6, a plurality of memory devices 141, 143, . . . , 145 are connected to a computer express link (CXL) fabric 121 to provide a unified space of random access memory (e.g., 112). A controller 122 of the fabric 121 is operable to dynamically map memory addresses in the unified space to physical memory addresses in portions of the memory devices 141, 143, . . . , 145.

For example, different portions of the unified space can be allocated as host memory buffers 167, . . . , 169 for different memory sub-systems 161, . . . , 163 respectively. Each of the memory sub-systems 161, . . . , 163 can have a separate host memory buffer (e.g., 167 or 169) in a way as the memory sub-system 101 having a host memory buffer 125 in FIG. 2 to FIG. 4.

In FIG. 5, the host memory buffer 167 allocated to the memory sub-system 161 is implemented, by the controller 122 via an address mapping 165, using portions of random access memories of different memory devices, such as a portion 151 of random access memory in one memory device 141, a portion 155 of random access memory in another memory device 143, etc. Thus, different portions of the host memory buffer 167 can be physically disaggregated across a plurality of memory devices (e.g., 141, 143).

Similarly, different portions of the host memory buffer 169 allocated to the memory sub-system 163 can be physically disaggregated across a plurality of memory devices (e.g., 141, 145). For example, one portion of the host memory buffer 169 is implemented by the controller 122 using a portion 153 of random access memory in one memory device 141; and another portion of the host memory buffer 169 is implemented by the controller 122 using a portion 157 of random access memory in another memory device 145.

The host memory buffers 167, . . . , 169 allocated to the different memory sub-system 161, . . . , 163 do not share a common portion from a same memory device. Thus, each portion (e.g., 151) allocated from a memory device (e.g., 141) to implement a host memory buffer (e.g., 167) is allocated for exclusive used as part of the host memory buffer (e.g., 167), not shared with another host memory buffer (e.g., 169) and not allocated for other uses.

Based on the current communication traffic in the fabric 121, the controller 122 can optionally adjust the mapping 165 to improve the performance of the system.

For example, the controller 122 can adjust the mapping 165 for the host memory buffers 167, . . . , 169 based on activities to access the memory devices 141, 143, . . . , 145 over the fabric. Such activities can include the activities of the memory sub-systems 161, . . . , 163 to access, via the fabric 121, the host memory buffers 167, . . . , 169 and thus various portions (e.g., 151, 155, 157) of the memory devices 141, 143, . . . , 145. Further, such activities relevant to the adjustment of the mapping 165 can include the activities of other devices (e.g., processing device(s) 118, devices 128, . . . , 129 illustrated in FIG. 2 to FIG. 4, such as artificial intelligence (AI) accelerator, graphical processing unit (GPU) using the random access memory provided via the fabric 121).

Different patterns of activities and different ways to allocate portions of the memory devices to the host memory buffers 167, . . . , 169 can have different impacts on traffic delays in the fabric 121. The controller 122 can decide changes in allocation of portions of the memory devices 141, 143, . . . , 145 to the host memory buffers 167, . . . , 169 to improve the performance of the host memory buffers 167, . . . , 169, and/or to improve the performance of the computing system 100 in using the memory devices 141, 143, . . . , 145.

For example, in FIG. 6, the host memory buffer 167 is implemented using the portion 157 of the memory device 145 and the portion 155 of the memory device 143; and the host memory buffer 169 is implemented using the portions 151 and 153 of the memory device 141.

In some instances, the use of the mapping as in FIG. 6 can reduce traffic jam in the fabric 121 and thus improve the system performance over the use of the mapping as in FIG. 5. Thus, the controller 122 can adjust the mapping 165 to implement the host memory buffers 167, . . . , 169 in a way as illustrated in FIG. 6, instead of implementing the host memory buffers 167, . . . , 169 in a way as illustrated in FIG. 5, based on a recent pattern of activities in the fabric 121.

The controller 122 can instruct the memory devices 141, 143, . . . , 145 to move, exchange, and/or relocate data such that the change in the mapping 165 for implementing the host memory buffers 167, . . . , 169 is shielded from the memory sub-systems 161, . . . , 163. The memory sub-system 161, . . . , 163 can use their respective host memory buffers 167, . . . , 169 without the need to be aware of how the host memory buffers 167, . . . , 169 are implemented using which portions of memory devices 141, 143, . . . , 145.

In general, the controller 122 can change the mapping 165 by changing which portions of the memory devices 141, 143, . . . , 145 are used to implement a host memory buffer (e.g., 167 or 169). Further, the size(s) of the portions allocated to implement the host memory buffer (e.g., 167 or 169) can change; and the number of portions used to implement the host memory buffer (e.g., 167 or 169) can change.

The controller 122 can make the change in the mapping 165 on the fly during the operations of the memory sub-systems 161, . . . , 163. It is not necessary for the memory sub-systems 161, . . . , 163 to stop their operations for the controller 122 to make the change; and it is not necessary for the memory sub-systems 161, . . . , 163 to restart to effectuate the change.

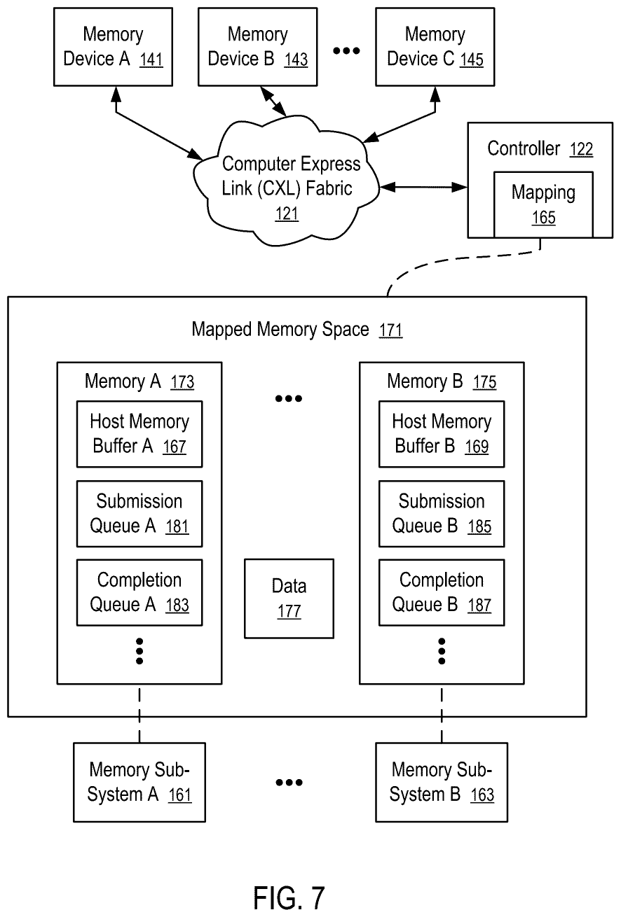

FIG. 7 shows a technique to access a memory sub-system using a memory space provided via a computer express link fabric according to one embodiment.

In FIG. 7, a unified/mapped memory space 171 is implemented via a controller 122 of a computer express link (CXL) fabric 121 connecting a plurality of memory devices 141, 143, . . . , 145 of random access memory (e.g., as in FIG. 2 to FIG. 6).

The mapped memory space 171 can have memories 173, . . . , 175 allocated respectively to memory sub-systems 161, . . . , 163.

The mapped memory space 171, implemented according to mapping 165 in the controller 122, can have different portions allocated as host memory buffers 167, . . . , 169 for different memory sub-systems 161, . . . , 163, as in FIG. 5 and FIG. 6.

Further, the portions of the mapped memory space 171 (e.g., memories 173, 175) configured for the memory sub-systems (e.g., 161, 163) can include cycle buffers for hosting submission queues (e.g., 181, 185) and completion queues (e.g., 183, 187). The queues (e.g., 181, 183, 185, 187) can be used to facilitate communications with the memory sub-systems 161, . . . , 163 for storage access (e.g., according to a non-volatile memory express (NVMe) standard).

For example, the memory 173 in the mapped memory space 171 can include a host memory buffer 167 allocated to the memory sub-system 161, a submission queue 181 for sending commands to the memory sub-system 161, and a completion queue 183 for receiving messages reporting completion of execution of the commands sent via the submission queue 181. In general, the memory 173 allocated from the mapped memory space 171 for the memory sub-system 161 can include a plurality of submission queues (e.g., 181) and a plurality of completion queues (e.g., 183).

In FIG. 7, a memory sub-system (e.g., 161) is allowed to retrieve commands from its submission queues (e.g., 181) but not allowed to retrieve commands from submission queues (e.g., 185) configured for other memory sub-systems (e.g., 163). Similarly, a memory sub-system (e.g., 161) is allowed to enter completion messages into its submission queues (e.g., 183) but not allowed to enter messages into completion queues (e.g., 185) configured for other memory sub-systems (e.g., 163).

The host system 102 can send commands (e.g., read commands, write commands) to a memory sub-system (e.g., 161, or 163) by entering the commands in a submission queue (e.g., 181 or 185) configured for the memory sub-system (e.g., 161, or 163).

For example, the processing device(s) 118 of the host system 102 can write a command into the submission queue 181 (e.g., in accordance with a NVMe standard); and the memory sub-system 161 can subsequently retrieve the command from the submission queue 181 (e.g., in accordance with the NVMe standard) for execution.

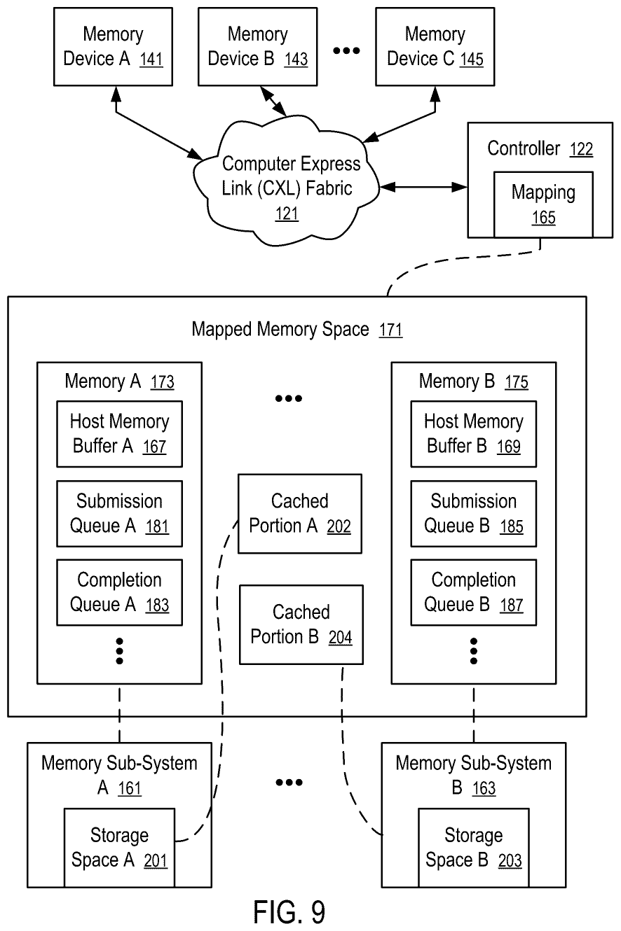

In some implementations, a submission queue (e.g., 181) in the mapped memory space 171 is reserved for the controller 122 of the computer express link fabric 121 to send commands to operate the respective memory sub-system (e.g., 161). For example, the controller 122 can use a portion of the memory space 171 to cache a portion of the memory sub-system 161 (e.g., as illustrated in FIG. 9) via sending commands to the memory sub-system (e.g., 161) via the submission queue (e.g., 181) without assistance from the processing device(s) 118. Thus, the processing device(s) 118 can access the cached portion of the memory sub-system 161 without the need to send storage access commands to the memory sub-system (e.g., 161) using a submission queue. The controller 122 can generate the storage access commands for the processing device(s) 118 in response to the memory access requests received in the fabric 121 from the processing device(s)

The host system 102 can enter a read command in the submission queue 185 configured for the memory sub-system 163. After the memory sub-system 163 retrieves the read command from the submission queue 185, the memory sub-system 163 can execute the read command to retrieve data (e.g., 177) from its storage medium (e.g., non-volatile memory cells 114) and write the data (e.g., 177) to a memory address identified in the read command. For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 163 can send the data (e.g., 177) to the memory address identified in the read command without assistance from the processing device(s) 118 of the host system 102.

The host system 102 can enter a write command in the submission queue 181 configured for the memory sub-system 161. After the memory sub-system 161 retrieves the write command from the submission queue 181, the memory sub-system 161 can execute the write command by retrieving data (e.g., 177) from a memory address identified in the write command and programming its storage medium (e.g., non-volatile memory cells 114) to store the data (e.g., 177). For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 161 can load the data (e.g., 177) from the memory address identified in the write command without assistance from the processing device(s) 118 of the host system 102.

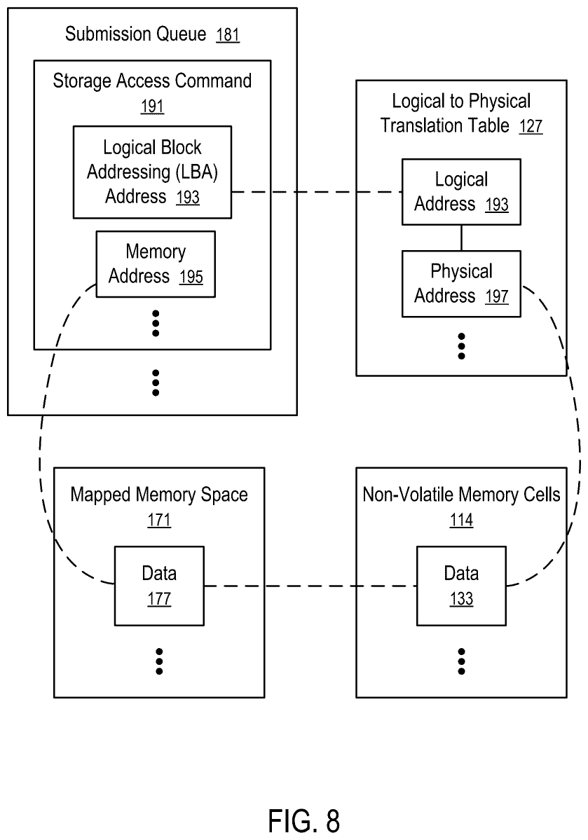

For example, the computing system 100 can be configured to execute a storage access command as illustrated in FIG. 8.

FIG. 8 illustrates execution of a storage access command according to one embodiment. For example, the commands provided in submission queues (e.g., 181 or 185) in FIG. 7 can be executed in a memory sub-system (e.g., 161 or 163) in a way as illustrated in FIG. 8.

In FIG. 8, a storage access command 191 in a submission queue 181 is configured to identify a logical block addressing (LBA) address 193 and a memory address 195.

The logical block addressing (LBA) address 193 identifies a logical location in a storage medium, such as non-volatile memory cells 114 of a memory sub-system 101 (e.g., 161 or 163 in FIG. 5 to FIG. 7).

The memory sub-system 101 has a logical to physical translation table 127 configured to map the LBA address 193 to the physical address 197 that can be used to address a set of memory cells among the non-volatile memory cells 114.

As in FIG. 2 to FIG. 7, at least a portion of the logical to physical translation table 127 can be buffered in the host memory buffer 125 (e.g., 167 or 169 for a memory sub-system 161 or 163 in FIG. 5 to FIG. 7).

In one embodiment, when the portion of the mapping between the logical address 193 and the physical address 197 is in the host memory buffer 125, the memory sub-system 101 can compute a location in the host memory buffer 125 where the physical address 197 associated with the logical address 193 is stored, and send a load command to load the physical address 197 from the host memory buffer 125 over the computer express link (CXL) fabric 121. Optionally, when the portion of the logical to physical translation table 127 is used frequently in recent operations, the buffer manager 113 can load the portion into the local memory 119 for further improved performance in address translation operations.

The memory address 195 can be configured to identify a location in the mapped memory space 171. With the memory address 195 and the physical address 197, the memory sub-system 101 can execute the storage access command 191 to transfer data for a read operation or a write operation.

For example, when the storage access command 191 includes an opcode for a read operation, the memory sub-system 101 can retrieve data 133 from the non-volatile memory cells 114, decode the data 133 using an error correction code (ECC) technique to obtain retrieved error-free data 177, and store the data 177 to the mapped memory space 171 at the memory address 195. In response to the memory sub-system 101 storing data 177 to the memory address 195, the controller 122 of the computer express link fabric 121 maps the memory address 195 in the memory space 171 to an address in a memory device (e.g., 141, 143, or 145) connected to the fabric 121, and route to the memory device (e.g., 141, 143, or 145) the request to store the data 177. Thus, the data 177 is physically stored in the memory device (e.g., 141, 143, or 145). Alternatively, the memory address 195 can be configured to identify a location in the main memory 124; and in response, the retrieved data 177 is stored to the location in the main memory 124.

For example, when the storage access command 191 includes an opcode for a write operation, the memory sub-system 101 can load data 177 from the location in the mapped memory space 171 as specified by the memory address 195, encode the data 177 using an error correction code (ECC) technique to generate data 133, allocate non-volatile memory cells 114 at the physical address 197 to store the data 133, update the logical to physical translation table 127 to map the logical block addressing address 193 to the physical address 197 of the allocated non-volatile memory cells 114, and program the allocated memory cells to have states representing the data 133. In response to the memory sub-system 101 loading data 177 from the memory address 195, the controller 122 of the computer express link (CXL) fabric 121 maps the memory address 195 in the memory space 171 to an address in a memory device (e.g., 141, 143, or 145) connected to the fabric 121, and route to the memory device (e.g., 141, 143, or 145) the request to load data 177. Alternatively, the memory address 195 can be configured to identify a location in the main memory 124; and in response, the data 177 is loaded from the location in the main memory 124.

In some implementations, portions of the storage spaces of memory sub-systems 161, . . . , 163 connected to the fabric 121 are cached in the mapped memory space 171 to accelerate access to the portions of the storage spaces of the memory sub-systems 161, . . . , 163, as illustrate in FIG. 9.

FIG. 9 illustrates a controller of a computer express link (CXL) fabric caching portions of memory sub-systems in the memory space provided by memory devices connected to the fabric according to one embodiment.

In FIG. 9, the memory sub-systems 161, . . . , 163 can be attached to a host system 102 having a computer express link (CXL) fabric 121 as in FIG. 2 to FIG. 7. Each of the memory sub-systems 161, . . . , 163 can be implemented in a way as in FIG. 1. The controller 122 of the fabric 121 can implement the mapped memory space 171 using the random access memory in the memory devices 141, 143, . . . , 145 connected to the CXL fabric 121.

For example, a memory sub-system 161 can have a storage space 201 addressable via logical block addressing (LBA) addresses (e.g., 193) as in FIG. 8 using storage access commands (e.g., 191). A portion of the storage space 201 can be cached in the mapped memory space 171 as a cached portion 202 that is physically mapped to one or more portions in the memory devices (e.g., 141, 143, and/or 145) connected to the fabric 121, in a way similar to the mapping of the host memory buffer 167 being implemented using portions of the memory devices 141, 143, . . . , 145 connected to the fabric 121.

Similarly, a storage space 203 in the memory sub-system 163 can have a portion cached as a cached portion 204 in the mapped memory space 171. The cached portion 204 can be implemented using portions of the memory devices 141, 143, . . . , 145, in a way similar to the implementation of the host memory buffer 169 allocated to the memory sub-system 163.

The processing device(s) 118 in the host system 102 can optionally access the memory sub-systems 161, . . . , 163 via entering storage access commands (e.g., 191) into the submission queues (e.g., 181, 185) configured for the memory sub-systems 161, . . . , 163, or send memory access commands to the fabric 121 using memory addresses of the cached portions (e.g., 202, 204).

Optionally, the controller 122 can be configured to present the entire storage space 201 of the memory sub-system 161 as a cached portion 202 in the mapped memory space 171 such that the processing device(s) 118 can use the storage space 201 without using storage access commands (e.g., 191) and without using submission queues (e.g., 181) configured for the memory sub-system 161. Thus, the submission queues (e.g., 181) configured for the memory sub-system 161 can be reserved for exclusive use by the controller 122 in implementing the cached portion 202. The processing device(s) 118 can access the cached portion 202 using memory access requests instead of storage access commands.

For example, the controller 122 can be configured to present (e.g., to the processing device(s) 118 and other devices 128, . . . 129 connected to the fabric 121) the entire storage space 201 of the memory sub-system 161 as a portion of a random access memory in the mapped memory space 171, as if the memory sub-system 161 were a random access memory device. For example, the storage space 201 can have a capacity larger than the combined random access memory capacity of the memory devices 141, 143, . . . , 145; and thus, the mapped memory space 171 can be larger than the combined random access memory capacity of the memory devices 141, 143, . . . , 145. The controller 122 can configure its mapping 165 to map an actively used portion of the storage space 201 as a cached portion 202 that is currently mapped to portions of the memory devices 141, 143, . . . , 145, while other portions of the storage space 201 as mapped to the memory space 171 are not concurrently implemented using the random access memory in the memory devices 141, 143, . . . , 145. The memory space 171 implemented using the storage space 201 can be actually implemented using the memory devices 141, 143, . . . , 145 one portion at time. Thus, the portion of the memory space 171 implemented using the storage space 201 can have persistent storage in the memory sub-system 161, while an actively used portion of the storage space 201 is implemented (e.g., mirror or cached) in the memory devices 141, 143, . . . , 145.

For example, when the processing device(s) 118 requests accesses to memory addresses in the mapped memory space 171 that correspond to a portion of the storage space 201, the controller 122 can determine a corresponding LBA address (e.g., 193) of the portion. If the storage space represented by the LBA address (e.g., 193) is not already cached or mirrored in the memory space 171 using random access memory of the memory devices 141, 143, . . . , 145, the controller 122 can dynamically allocate one or more portions from the memory devices 141, 143, . . . , 145, enter a read command in the submission queue 181 configured for the memory sub-system 161 to retrieve the data at the LBA address (e.g., 193) into the cached portion 202 implemented using the dynamically allocated portions of the memory devices 141, 143, . . . , 145, and route the memory access requests from the processing device(s) 118 over the fabric 121 to the memory devices 141, 143, . . . , 145.

When the controller 122 determines that the cached portion 202 is not likely to be accessed by the processing device(s) 118 in a subsequent period of time and the content of the cached portion 202 has not yet been committed into the storage space 201, the controller 122 can enter a write command in the submission queue 181 to write the data of the cached portion 202 into the memory sub-system 161. Upon receiving a completion message in the completion queue 183 that indicates the completion of the write command, the controller 122 can free the random access memory allocated from the memory devices 141, 143, . . . , 145 to implement the cached portion 202, which can then be reused to implement another cached portion of the storage space 201 of the memory sub-system 161, or a cached portion 204 of the storage space 203 of another memory sub-system 163.

Thus, the controller 122 can effectively provide a unified memory and storage service to devices (e.g., 118, 128, 129) connected to the computer express link (CXL) fabric 121 through the use of mapping 165 to route memory access requests to the memory devices 141, 143, . . . , 145 over the CXL fabric 121 and the use of the submission queues (e.g., 181, 185) and completion queues (e.g., 183, 187) to operate the memory sub-systems 161, . . . , 163. The devices (e.g., 118, 128, 129) can access the storage spaces 201, . . . , 203 of the memory sub-systems 161, . . . , 163 via the memory devices 141, 143, . . . , 145 that are dynamically mapped by the controller 122 as proxies. Since the tasks of using message queues (e.g., 181, 183, 185, 187) to communicate with memory sub-systems (e.g., 161, 163) are offloaded to the controller 122 of the CXL fabric 121, the complexity of routines and applications running in the processing devices (e.g., 118, 128, 129) can be reduced.

Optionally, the entire portion of the memory space 171 that is accessible to the host devices (e.g., 118, 128, 129) of the CXL fabric 121 is mapped to the storage spaces 201, . . . , 203 of the memory sub-systems. Thus, the random access memory provided by the fabric 121 to the host devices (e.g., 118, 128, 129) can be used as a non-volatile random access memory.

Optionally, the controller 122 can dynamically adjust the mapping 165 of which portions of the mapped memory space 171 are mapped to which of the memory sub-systems 161, . . . , 163 connected to the CXL fabric 121. The controller 122 can adjust the mapping 165 to balance the workloads on the memory sub-systems 161, . . . , 163 and thus improve the performance of the system.

The unified memory and storage services allow the host devices (e.g., 118, 128, 129) connected to the CXL fabric 121 to access the mapped memory space 171 using memory addresses (e.g., 195) and memory access requests at a granularity of random memory access (e.g., in a unit of one byte, eight bytes, or 128 bytes), while the data stored into at least a portion of the memory space 171 is stored persistently in the storage spaces (e.g., 201, 203) of the memory sub-systems 161, . . . , 163. The host devices (e.g., 118, 128, 129) can be relieved from operations to enter commands in submission queues (e.g., 181, 185) configured for the memory sub-system 161, . . . , 163. At least a portion of the random access memory of the memory devices 141, 143, . . . , 145 can be used dynamically by the controller 122 as the cache memory for access in the storage spaces 201, . . . , 203 of the memory sub-systems 161, . . . , 163, without the host devices (e.g., 118, 128, 129) performing operations to manage or effectuate the caching.

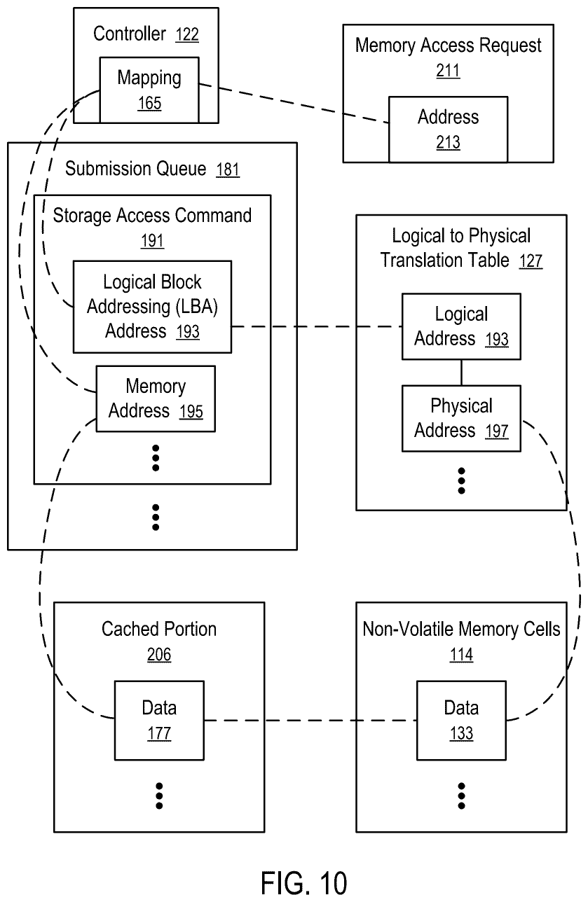

FIG. 10 illustrates communications to implement a memory access request according to one embodiment. For example, when a device (e.g., 118, 128, 129) sends a memory access request 211 into the computer express link (CXL) fabric 121 in FIG. 9 to access a location in the memory space 171 that is mapped to a location in a storage space 201 in the memory sub-system 161, the memory access request 211 can be processed in a way as illustrated in FIG. 10.

In FIG. 10, when a memory access request 211 is received in the computer express link (CXL) fabric 121, the controller 122 uses its mapping 165 to determine how to route the memory access request 211 to a memory device (e.g., 141, 143, or 145) that is connected to the fabric to provide a random access memory.

Based on the mapping 165, the controller 122 can determine that the address 213 is in a portion of the mapped memory space 171 that is configured as a cached portion 206 of the storage space 201 provided by non-volatile memory cells 114 in a memory sub-system 161. Alternatively, or in combination, the controller 122 can determine that the address 213 is in a portion 206 of the mapped memory space 171 that has persistent storage implemented in the storage space 201 provided by non-volatile memory cells 114 in the memory sub-system 161.

In response, the controller 122 can determine whether the cached portion 206 is already implemented using the random access memory of the memory devices 141, 143, . . . , 145 on the fabric 121. If not, the controller can generate a storage access command 191 to implement the caching of the portion of the non-volatile memory cells 114 in the cached portion 206.

For example, the controller 122 can allocate a portion of the random access memory of the memory devices 141, 143, . . . , 145 as the cached portion 206 identified by a memory address 195 in the mapped memory space 171 such that memory access requests addressing the memory address 195 is routed to one of the memory devices 141, 143, . . . , 145 over the fabric 121. Further, based on the mapping 165, the controller 122 can determine the logical block addressing (LBA) address 193 for retrieving data 177 from the non-volatile memory cell 114 to the cached portion 206 in a way as illustrated in FIG. 8. After the memory sub-system 161 executes the storage access command 191, the controller 122 can route the memory access request 211 over the fabric 121 to a memory device (e.g., 141, 143, . . . , or 145) according to the mapping 165 from the memory address 195 to the address in the memory device (e.g., 141, 143, . . . , or 145) used to implement the cached portion 206.

Subsequently, when the controller 122 determines that the cached portion 206 is not going to be accessed for a period of time, the controller 122 can enter a write command in the submission queue 181 to write the data 177 in the cached portion 206 into the memory sub-system 161 at the logical block addressing (LBA) address 193, as in FIG. 8. Thus, the data of the cached portion 206 has persistent storage in the non-volatile memory cells 114 in the memory sub-system 161.

In some implementations, a buffer manager 113 is configured in the controller 122 of the computer express link (CXL) fabric 121 to implement the caching of portions of storage spaces 201, . . . , 203 of the memory sub-systems 161, . . . , 163, as discussed above in connection with FIG. 9 and FIG. 10.

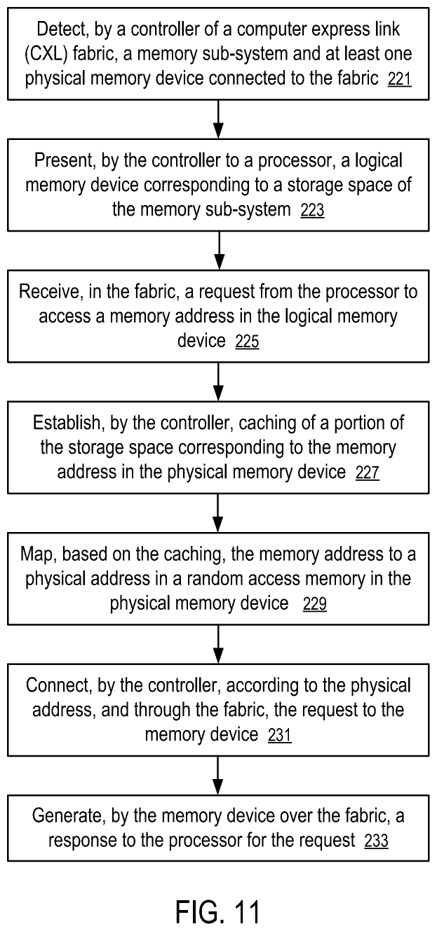

FIG. 11 to FIG. 13 show methods to provide memory access to a storage space of a memory sub-system according to some embodiments. For example, the methods of FIG. 11 to FIG. 13 can be implemented via a buffer manager 113 running in a controller 122 of a computer express link (CXL) fabric 121 as in FIG. 2 to FIG. 10.

In some implementations, a controller 122 of a CXL fabric 121 can present a memory sub-system 161, connected to the CXL fabric 121 and having a storage space 201 to be accessed via LBA addresses and submission queues (e.g., 181), as a logical memory device having a random access memory that is accessible via memory access requests (e.g., 211) that are routed over the fabric 121 to memory devices 141, 143, . . . , 145, as in the method of FIG. 11.

At block 221 in FIG. 11, a controller 122 of a computer express link (CXL) fabric 121 detects a memory sub-system 101 (e.g., 161 or 163) and at least one physical memory device (e.g., 141, 143, . . . , 145) that are connected to the fabric 121.

At block 223, the controller 122 presents, to a processor, a logical memory device corresponding to a storage space (e.g., 201, or 203) of the memory sub-system (e.g., 161, or 163).

For example, at least the persistent storage of data in the logical memory device is implemented by the controller 122 in the storage space (e.g., 201, or 203) of the memory sub-system (e.g., 161, or 163).

For example, the processor can be a central processing unit (CPU) or system on a chip (SoC) (e.g., processing device(s) 118), or an artificial intelligence (AI) accelerator or graphical processing unit (GPU) (e.g., devices 128 or 129), in a host system 102 that contains the CXL fabric 121.

For example, the logical memory device can have memory addresses in a cached portion (e.g., 202 or 204) in a mapped memory space 171 addressable, using memory addresses (e.g., 195), by a device (e.g., 118, 128, 129) connected to the fabric 121. Memory addresses in the mapped memory space 171 are mapped by the controller 122 to random access memories in the at least one physical memory device (e.g., 141, 143, . . . , 145) connected to the fabric 121.

At block 225, the fabric 121 receives a request (e.g., 211) from the processor to access a memory address 213 in the logical memory device.

At block 227, the controller 122 establishes caching, in the physical memory device (e.g., 141, 143, or 145), of a portion of the storage space (e.g., 201, or 203) corresponding to the memory address (e.g., 213), e.g., as in FIG. 10.

At block 229, the controller 122 maps, based on the caching established at block 227, the memory address 213 to a physical address in a random access memory in the physical memory device (e.g., 141, 143, or 145).

For example, the techniques of mapping a portion of a host memory buffer (e.g., 167) to a portion in a memory device (e.g., 141, 143, or 145) in FIG. 5 and FIG. 6 can be used to map a cached portion 206 of the storage space (e.g., 201 or 203) to a portion (e.g., 151 or 155) in a memory device (e.g., 141 or 143).

At block 231, the controller 122 connects, through the fabric 121 and according to the physical address, the request 211 to the memory device (e.g., 141 or 143).

For example, the fabric 121 can include one or more CXL switches and a plurality of point to point CXL connections. The controller 122 can provide instructions to the switches to route the request 211 (e.g., by replacing the address 213 with the physical address in the memory device (e.g., 141 or 143)).

At block 233, the memory device (e.g., 141 or 143) generates, over the fabric 121, a response to the processor for the request 211.

For example, the request 211 can be configured to store or load a unit of data to or from a memory location identified by the address 213. The unit of data can have a size (e.g., one byte, 16 bytes, 128 bytes) that is significantly smaller than a block of data (e.g., 512 bytes or 4 KB) configured to be addressed by a logical block addressing (LBA) address (e.g., 193) used in the memory sub-system (e.g., 161, or 163).

After the cached portion has not been accessed for a period of time, the controller 122 of the computer express link fabric can write the date from the memory device (e.g., 141 or 143) to the memory sub-system (e.g., 161 or 163) and free the random access memory previously allocated to implement the cached portion 206 (e.g., 202 or 204).

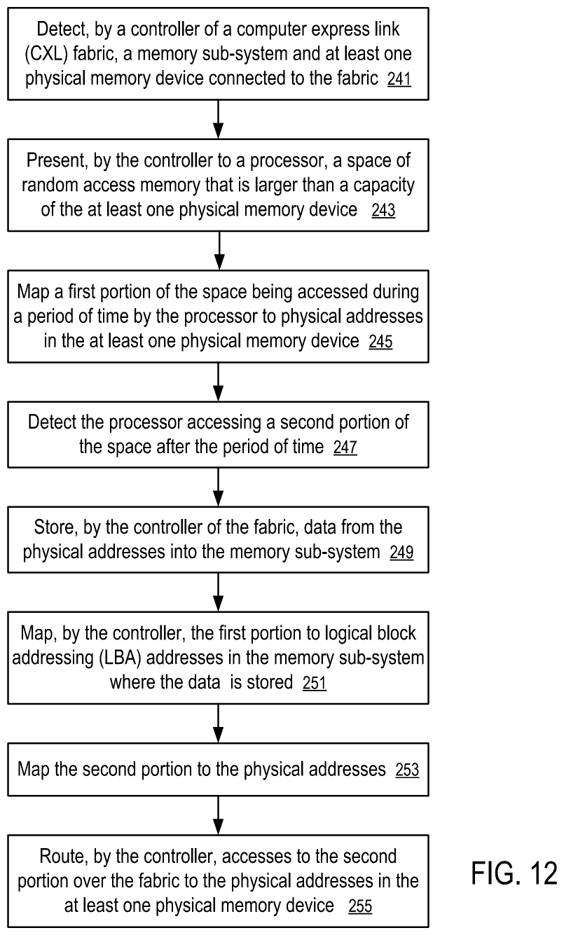

In some implementations, the controller 122 of the CXL fabric 121 can dynamically allocate a portion of random access memory provided by memory devices 141, 143, . . . , 145 on the fabric 121 as the cache memory of an active portion of the storage space (e.g., 201) of a memory sub-system 161 to allow a device (e.g., 118, 128, 129) connected to the CXL fabric 121 to access the storage space via the cache memory addressable using a memory address in the mapped memory space 171, as in FIG. 12. Thus, the mapped memory space 171 can be configured, based on the storage space 201 of the memory sub-system 161, to be larger than the combined memory capacity of the memory devices 141, 143, . . . , 145.

At block 241 in FIG. 12, a controller 122 of a computer express link (CXL) fabric 121 detects a memory sub-system 101 (e.g., 161 or 163) and at least one physical memory device (e.g., 141, 143, . . . , 145) connected to the fabric 121.

At block 243, the controller 122 presents, to a processor (e.g., device 118, 128 or 129), a space 171 of random access memory that is larger than a capacity of the at least one physical memory device (e.g., 141, 143, . . . , 145).

For example, a portion of the mapped memory space 171 can be mapped to the storage space 201 of the memory sub-system 161. However, different sections of the portion of the space 171 mapped to the storage space 201 are not concurrently usable. Instead, one or more sections that correspond to actively in-use portions of the storage space 201 are configured as cached portions (e.g., 202) of the storage space 201 using random access memories allocated from the at least one physical memory device (e.g., 141, 143, . . . , 145). Other sections are not usable until the some of the random access memories of the at least one physical memory device (e.g., 141, 143, . . . , 145) are reallocated to implement the caching of the respective sections of the storage space 201. Thus, a smaller amount of random access memory provided by the at least one physical memory device (e.g., 141, 143, . . . , 145) can be used to implement caching for accessing the storage space 201 a few sections at a time.

At block 245, the controller 122 maps a first portion of the space 171 being accessed during a period of time by the processor (e.g., 118, 128, 129) to physical addresses in the at least one physical memory device (e.g., 141, 143, . . . , 145).

For example, when the host system 102 is actively using the cached portion 202 of the space 171, the controller 122 can implement the cached portion 202 of the space 171 using the random access memory of the memory devices 141, 143, . . . , 145 (e.g., as in FIG. 10).

At block 247, the controller 122 detects the processor (e.g., 118, 128, 129) accessing a second portion of the space 171 after the period of time.

For example, the second portion of the space 171 is currently not mapped to any of the memory devices 141, 143, . . . , 145. To facilitate random access to the second portion of the space 171 using memory access requests, the controller 122 can reuse a portion of the random access memory previously used to implement the cached portion 202. The controller 122 can enter storage access commands (e.g., write commands) in the submission queue (e.g., 181) configured for the memory sub-system 161 to store the data from the cached portion 202 into the storage space 201 of the memory sub-system 161, and enter further storage access commands (e.g., read commands) to retrieve the data corresponding to the second portion of the space 171 from the storage space 201 of the memory sub-system 161 into the reused portion of the random access memory that is now mapped to the second portion of the space 171. Memory access requests addressing the second portion of the space 171 are then routed via the CXL fabric 121 to the reused portion of the random access memory of the memory devices 141, 143, . . . , 145.

At block 249, the controller 122 of the fabric 121 stores data (e.g., 177) from the physical addresses into the memory sub-system (e.g., 161).

For example, the controller 122 can enter a write command (e.g., storage access command 191) in the submission queue 181 configured for the memory sub-system 161 to write the data 177 from the memory address 195 corresponding to the physical addresses in the physical memory devices 141, 143, . . . , 145 to one or more LBA addresses (e.g., 193) in the memory sub-system 161. After the execution of the write command, the random access memory previously used to implement the cached portion 202 can be freed and reused to implement the second portion of the space 171 that is being accessed by the processor (e.g., 118, 128, 129).

At block 251, the controller 122 maps the first portion (e.g., cached portion 202) to logical block addressing (LBA) addresses (e.g., 193) in the memory sub-system (e.g., 161) where the data is stored.

For example, if subsequently, the processor (e.g., device 118, 128, or 129) is to access the first portion (e.g., cached portion 202), the controller 122 can again allocate a portion of the random access memory of the memory devices 141, 143, . . . , 145 to implement the first portion (e.g., cached portion 202) and send a read command to the memory sub-system (e.g., 161) to retrieve the data from the LBA addresses (e.g., 193) to the first portion (e.g., cached portion 202). The portion of the random access memory of the memory devices 141, 143, . . . , 145 allocated to re-implement the first portion (e.g., cached portion 202) can be the same portion used to implement the first portion previously, or a different portion.

At block 253, the controller 122 maps the second portion to the physical addresses of the at least one physical memory device (e.g., 141, 143, . . . , 145). Thus, the random access memory at the physical addresses of the at least one physical memory device (e.g., 141, 143, . . . , 145), previously used to implement the first portion (e.g., cached portion 202), is reused to implement the second portion.

Alternatively, a different portion of the random access memory in the at least one physical memory device (e.g., 141, 143, . . . , 145) can be allocated to implement the second portion of the space 171.

At block 255, the controller 122 routes accesses to the second portion over the fabric 121 to the physical addresses in the at least one physical memory device (e.g., 141, 143, . . . , 145).

For example, the controller 122 can use the submission queue 181 configured for the memory sub-system 161 to retrieve data from the corresponding portion of the storage space 201 into the second portion of the space 171 to facilitate the requests to load data from memory addresses in the second portion of the space 171.

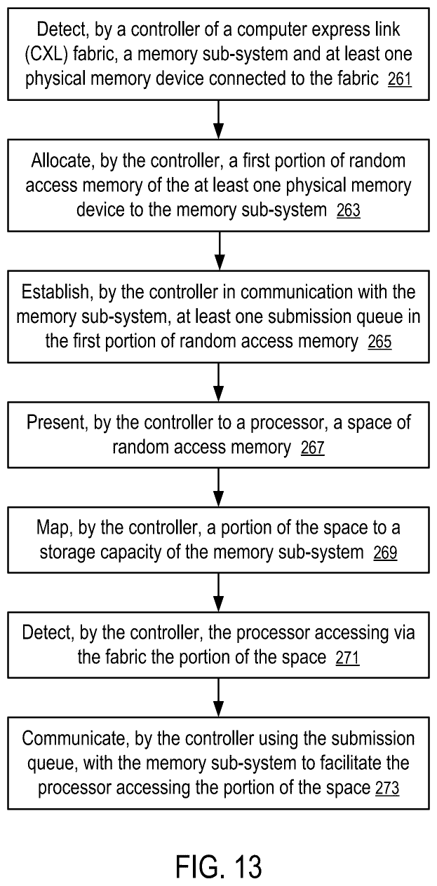

In some implementations, the controller 122 of the CXL fabric 121 can dynamically allocate a portion of random access memory provided by memory devices 141, 143, . . . , 145 on the fabric 121 (e.g., memory 173) as cyclic buffers for message queues (e.g., submission queue 181 and completion queue 183) to communicate with the memory sub-system 161 in implementing the mapped memory space 171, as in FIG. 13. The cyclic buffers (e.g., submission queue 181 and completion queue 183) are reserved from communications between the controller 122 and the memory sub-system 161. When the cyclic buffers are not in use, the random access memory allocated to implement the cyclic buffers can be reused for implementing other portions (e.g., 202 or 204) of the mapped memory space 171. Thus, the controller 122 can use the mapping 165 to pool the random access memories of the memory devices 141, 143, . . . , 145 together to dynamically meet the memory access demands through the CXL fabric 121.

Optionally, the message queues (e.g., submission queue 181 and completion queue 183) can be configured for sharing between the memory sub-system 161 and the controller 122, but not accessible to other devices (e.g., 118, 128, 129) such that the operations of the memory sub-system 161 is controlled exclusively by the controller 122 (e.g., to implement persistent data storage of the mapped memory space 171).

A portion of the mapped memory space 171 (e.g., memory 173) configured for the memory sub-system 161 can include a host memory buffer 167 for storing at least a portion of logical to physical translation table 127 of the memory sub-system 161. The mapping of portions of the host memory buffer 167 to the portions (e.g., 151, 155) in the memory devices 141, 143, . . . , 145 can be implemented dynamically in response to the usages of the logical to physical translation table 127. Thus, the controller 122 can allocate a large portion of the mapped memory space 171 to the memory sub-system 161 as the host memory buffer 167. Further, the controller 122 can implement the persistent storage of the data in the host memory buffer 167 in another memory sub-system 163, in a way similar to the implementation of the persistent storage of data 177 in a storage space (e.g., 201 or 203) in a memory sub-system (e.g., 161 or 163).

At block 261 in FIG. 13, a controller 122 of a computer express link (CXL) fabric 121 detects a memory sub-system 101 (e.g., 161 or 163) and at least one physical memory device (e.g., 141, 143, . . . , 145) connected to the fabric 121.

Based on the resources offered by the memory sub-system 101 (e.g., 161 or 163) and the at least one physical memory device (e.g., 141, 143, . . . , 145), the controller 122 can implement a mapped memory space 171 of random access memory accessible to a processor (e.g., 118, 128, 129) in the host system 102, such as devices 118, 128, . . . , 129.

The mapped memory space 171 of random access memory can be further accessible to the memory sub-system 101 (e.g., 161 or 163) in execution of storage access commands (e.g., 191, such as read commands, write commands configured according to a standard of non-volatile memory express (NVMe)).

At block 263, the controller 122 allocates a first portion of random access memory of the at least one physical memory device 141, 143, . . . , 145 to the memory sub-system (e.g., 161).

For example, the first portion of random access memory of the at least one physical memory device 141, 143, . . . , 145 can be allocated to implement memory 173 in the mapped memory space 171.

At block 265, the controller 122 establishes, in communication with the memory sub-system 161 (e.g., during a boot up time of the memory sub-system 161), at least one submission queue 181 in the first portion of random access memory (e.g., mapped to the memory 173 in the memory space 171).

At block 267, the controller 122 presents, to a processor, a space 171 of random access memory.

In some implementations, the space 171 can include the memory 173 and configured to allow the processor (e.g., device 118, 128, or 129) to access at least a portion of the memory 173 (e.g., the submission queue 181 and the completion queue 183).

In other implementations, the space 171 of random access memory presented to the processor (e.g., as a logical memory device) is configured to exclude the memory 173 that is reserved for exclusive use by the controller 122 and the memory sub-system 161. For example, the memory 173 can be configured in a logical memory device that is not visible the processor (e.g., 118, 128, 129).

At block 269, the controller 122 maps a portion of the space 171 (e.g., presented to the processor as a logical memory device having a random access memory) to a storage capacity or space 201 of the memory sub-system 161.

At block 271, the controller 122 detects the processor accessing via the fabric 121 the portion of the space 171.

At block 273, the controller 122 communicates, using the submission queue 181, with the memory sub-system 161 to facilitate the processor accessing the portion of the space 171.

For example, the controller 122 can remap the portion of the space 171 to a second portion of random access memory of the at least one physical memory device 141, 143, . . . , 145, and load data from the portion of the storage capacity or space 201 of the memory sub-system 161 to the second portion of random access memory of the at least one physical memory device 141, 143, . . . , 145.

For example, after the controller 122 determines that the portion of the portion of the space 171 is not in active use, the controller 122 can issue a write command to the memory sub-system 161 to store the data from the portion of the space 171 into the storage space 201 of the memory sub-system 161 and free the second portion of random access memory of the at least one physical memory device 141, 143, . . . , 145 for other uses.

The techniques of dynamically implementing a portion of the mapped memory space 171 using a portion of random access memories of the memory devices 141, 143, . . . , 145 can also be used in the implementations of portions of the memory 173 allocated to the memory sub-system 161, such as a portion of the host memory buffer 167, the submission queue 181, and/or the completion queue 183. Thus, based on the current patterns of usages of the mapped memory space 171 and/or the communication traffic in the CXL fabric 121, the controller 122 can adjust its mapping 165 to maximize the system performance and utilization of the memory devices 141, 143, . . . , 145.

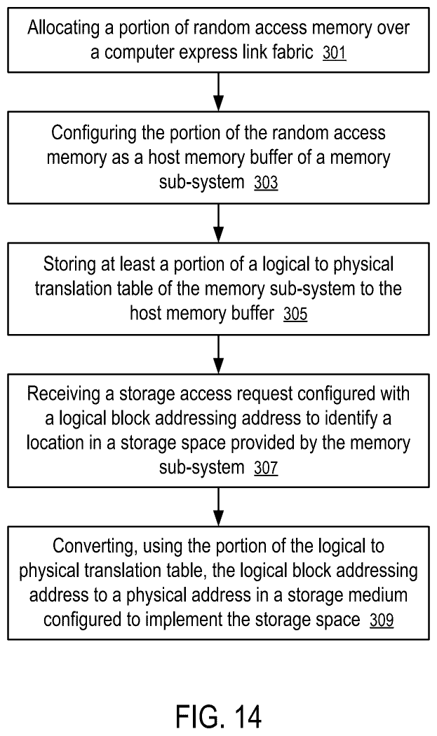

FIG. 14 shows a method to implement a disaggregated host memory buffer via random access memory connected via a computer express link fabric according to one embodiment. For example, the method of FIG. 14 can be implemented in the computing system 100 of FIG. 1 using the techniques discussed above in connection with FIG. 2 to FIG. 13.

For example, the computing system (e.g., 100 of FIG. 1) can have a computer express link fabric 121, a random access memory 112 provided by a plurality of memory devices (e.g., 123; 141, 143, . . . , 145) having random access memory cells, a memory bus 109, a main memory 124, at least one processing device 118 connected to the main memory 124 via the memory bus 109 and connected to the computer express link fabric 121, a peripheral bus 107, and a plurality of memory sub-systems (e.g., 101; 161, . . . , 163) connected to the at least one processing device via the peripheral bus 107. Each of the plurality of memory devices (e.g., 123; 141, 143, . . . , 145) is connected to the computer express link fabric 121 via a separate computer express link connection. The processing device(s) is a central processing unit, or cores of a central processing unit, or a system on a chip.

In the computing system 100, a plurality of portions of the random access memory cells in the plurality of memory devices (e.g., 123; 141, 143, . . . , 145) can be allocated respectively as a plurality of host memory buffers (e.g., 167, . . . , 169) for the plurality of memory sub-systems (e.g., 161, . . . , 163). Each of the host memory buffers (e.g., 167, . . . , 169) is allocated for exclusive use by one of the plurality of memory sub-systems (e.g., 161, . . . , 163).

For example, a first host memory buffer (e.g., 167), among the host memory buffers (e.g., 167, . . . , 169), includes portions (e.g., 151, 155) of random access memory cells allocated from more than one of the plurality of memory devices. Thus, the first host memory buffer (e.g., 167) can be physically disaggregated across multiple memory devices (e.g., 141, 143) that have separate computer express link connects to the fabric 121.

For example, the computer express link fabric 121 can be configured to map memory addresses in the first host memory buffer 167 to physical memory addresses of random access memory cells in the more than one of the plurality of memory devices (e.g., 141, 143).

For example, the computer express link fabric 121 can have a plurality of computer express link switches and a plurality of computer express link connections among the switches. The computer express link fabric 121 can include controller 122 that is configured to monitor memory access traffic going through the computer express link fabric 121 and adjust, based on the memory access traffic, mapping from the memory addresses in the first host memory buffer 167 to physical memory addresses of random access memory cells in the plurality of memory devices (e.g., 141, 143). The adjustment can be performed without restarting of any of the memory sub-systems 161, . . . , 163.

For example, each of the plurality of memory sub-systems 161, . . . , 163 is configured with a flash translation layer having a logical to physical translation table (e.g., 127) and configured to store at least a portion of the logical to physical translation table (e.g., 127) in one of the host memory buffers (e.g., 125; 167, or 169) allocated to the respective memory sub-system (e.g., 101; 161, or 163).

At block 301, the method of FIG. 14 includes allocating a portion of random access memory 112 over a computer express link fabric 121.

For example, the random access memory 112 is configured in a plurality of memory devices (e.g., 123; 141, 143, . . . , 145) connected to the computer express link fabric 121.

At block 303, the method includes configuring the portion of the random access memory 112 as a host memory buffer 125 of a memory sub-system 101.

For example, the host memory buffer 125 includes a plurality of portions (e.g., 151, 155) configured respectively in the plurality of memory devices (e.g., 141, 143).

At block 305, the method includes storing at least a portion of a logical to physical translation table 127 of the memory sub-system 101 to the host memory buffer 125.

At block 307, the method includes receiving a storage access request (e.g., command 191) configured with a logical block addressing address 193 to identify a location in a storage space provided by the memory sub-system 101 (e.g., a physical address of a set of non-volatile memory cells 114).

At block 309, the method includes converting, using the portion of the logical to physical translation table 127 in the host memory buffer 125, the logical block addressing address 193 to a physical address 197 in a storage medium (e.g., non-volatile memory cells 114) configured to implement the storage space.

For example, locations in the host memory buffer (e.g., 125 or 167) ca be addressable by the memory sub-system (e.g., 101 or 161) using memory addresses in a mapped memory space 171. The method of FIG. 14 can further include: mapping the memory addresses (e.g., 195) identified in memory access requests, received in the computer express link fabric 121, to physical memory addresses in the plurality of memory devices (e.g., 123; 141, 143, . . . , 145); and routing the memory access requests through the computer express link fabric 121 based on the mapping. For example, the memory access requests can be from the memory sub-system 101 to access the host memory buffer 125 (e.g., to buffer a portion of the logical to physical translation table 127, to perform a lookup of a physical address 197 corresponding to a logical address 193, etc.). For example, the method of FIG. 14 can further include: changing the mapping based at least in part on traffic patterns in the computer express link fabric 121; and the mapping can be changed without restarting any of the memory sub-systems (e.g., 161, . . . , 163) connected to the fabric 121.

For example, the storage access request (e.g., command 191) can include an opcode for a write operation; and the method of FIG. 14 can further include: updating the portion of the logical to physical translation table 127 in the host memory buffer (e.g., 125 or 167) in response to execution of the write operation.

For example, the storage access request (e.g., command 191) include an opcode for a read operation; and the method of FIG. 14 can further include: determining a memory location in the host memory buffer (e.g., 125 or 167) based on the logical block addressing address 193; transmitting into the computer express link fabric 121 a memory address request to load the physical address 197 from the memory location; and performing the read operation using the physical address 197.

For example, the memory sub-system 101 or 161 can have a host interface 108 configured to operate on a computer bus 107; non-volatile memory cells 114 configured to provide a persistent storage space 201 addressable over the host interface 108 via logical block addressing addresses (e.g., 193). The memory sub-system 101 or 161 can further include at least one processing device 117 configured (e.g., via firmware) to: process storage access requests (e.g., command 191) received over the host interface 108; allocate a portion of random access memory 112 over the host interface 108 and a computer express link fabric 121; buffer at least a portion of a logical to physical translation table 127 in the portion of random access memory 112; and convert, using the portion of the logical to physical translation table 127 buffered in the portion of the random access memory 112, the logical block addressing addresses (e.g., 193) to physical addresses (e.g., 197) of the non-volatile memory cells 114 in processing of the storage access requests (e.g., command 191). For example, the at least one processing device 117 can be configured (e.g., via firmware) to operate the portion of the random access memory 112 as a host memory buffer (e.g., 125 or 167).

For example, the non-volatile memory cells 114 can be NAND memory cells configured to be written to in the memory sub-system 101 at minimum of one page at a time, and to be erased in the memory sub-system at minimum of one block of predetermined number of pages at a time. The memory sub-system 101 cannot erase some of the pages in the block without erasing other pages in the block.

For example, the random access memory 112 is volatile (e.g., DRAM or SRAM); and the at least one processing device 117 can be further configured to maintain, in the non-volatile memory cells 114, a persistent copy of the logical to physical translation table 127 as metadata 131.

For example, the computer bus 107 can be a peripheral component interconnect express (PCIe) bus; and the memory sub-system (e.g., 101 or 161) can further include: a local memory 119; and a direct memory access engine 135 configured to copy the portion of the logical to physical translation table 127 between the local memory and the portion of the random access memory 112 allocated from the more than one of the plurality of memory devices (e.g., 123; 141, 143, . . . , 145).

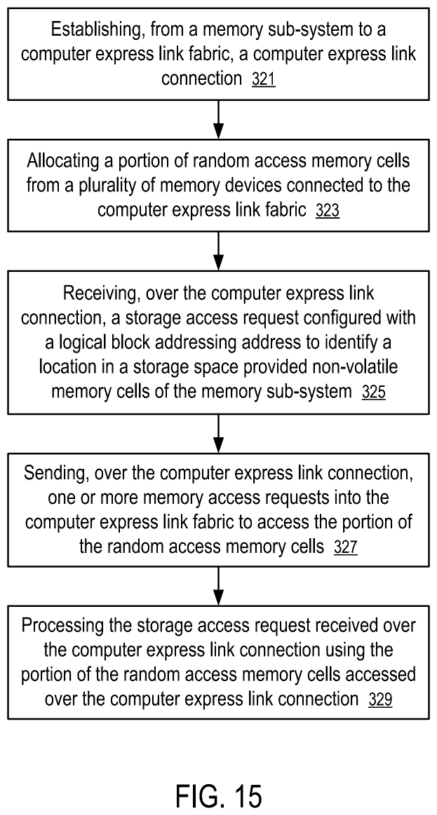

FIG. 15 shows a method to implement storage services via a memory sub-system having a computer express link connection to access random access memory cells connected via a computer express link fabric according to one embodiment. For example, the method of FIG. 15 can be implemented in the computing system 100 of FIG. 1 using the techniques discussed above in connection with FIG. 2 to FIG. 13.

For example, the computing system (e.g., 100) can include: a computer express link fabric 121; a plurality of memory devices (e.g., 123; 141, 143, . . . , 145) having random access memory cells to provide a random access memory 112; and a memory sub-system (e.g., 101, 161, or 163) having non-volatile memory cells 114 to provide a storage space (e.g., 201 or 203). For example, each of the plurality of memory devices (e.g., 123; 141, 143, . . . , 145) and the memory sub-system (e.g., 101, 161, or 163) is connected to the computer express link fabric 121 via a separate computer express link connection.

For example, the memory sub-system (e.g., 101, 161 or 163) can be configured to use a portion of the random access memory cells, in the plurality of memory devices (e.g., 123; 141, 143, . . . , 145) but outside of the memory sub-system (e.g., 101, 161 or 163), in processing a storage access request (e.g., command 191) received via the computer express link fabric 121.

For example, the storage access request (e.g., command 191) can include a logical block addressing address 193 to identify a subset of the non-volatile memory cells 114; and the memory sub-system (e.g., 101, 161, or 163) is configured to translate the logical block addressing address 193 to a physical address 197 of the subset of the non-volatile memory cells 114 using a portion of logical to physical translation table 127 stored in the portion of the random access memory cells.

For example, the portion of the logical to physical translation table 127 in the random access memory cells can be allocated from more than one of the plurality of memory devices (e.g., 123; 141, 143, . . . , 145).

For example, the computer express link fabric 121 can be configured to map memory addresses provided by memory access requests entering the computer express link fabric 121 to physical addresses of respective random access memory cells in the plurality of memory devices (e.g., 123; 141, 143, . . . , 145). The computer express link fabric 121 can include a plurality of computer express link switches, and a controller 122 is configured to: monitor memory access traffic going through the computer express link fabric 121; and dynamically adjust, based on the memory access traffic, mapping from memory addresses provided by memory access requests entering the computer express link fabric 121 to physical addresses of respective random access memory cells in the plurality of memory devices (e.g., 123; 141, 143, . . . , 145) to reduce latency of requests propagating through the fabric 121.

For example, a submission queue (e.g., 181 or 185) can be configured in a subset of the random access memory cells in the random access memory 112; and the memory sub-system (e.g., 101, 161, or 163) can be configured to retrieve the storage access request (e.g., command 191) from the submission queue (e.g., 181 or 185).

At block 321, the method of FIG. 15 includes establishing, from a memory sub-system (e.g., 101, 161 or 163) to a computer express link fabric 121, a computer express link connection (e.g., 107 as in FIG. 4).

For example, the memory sub-system (e.g., 101, 161 or 163) can have a host interface 108 configured to operate on a computer express link connection (e.g., as in FIG. 4). The memory sub-system (e.g., 101, 161 or 163) can have non-volatile memory cells 114 configured to provide a persistent storage space addressable over the host interface 108 via logical block addressing addresses (e.g., 193). The memory sub-system (e.g., 101, 161 or 163) can include at least one processing device 117 configured via firmware to implement a buffer manager 113 to perform the operations discussed in connection with host memory buffers 125, 167, and 169 and/or to perform other operations of the memory sub-system (e.g., 101, 161 or 163).

For example, the non-volatile memory cells 114 in the memory sub-system 101, 161 or 163 can be NAND memory cells configured to be written to in the memory sub-system at minimum of one page at a time, and to be erased in the memory sub-system at minimum of one block of predetermined number of pages at a time. A block is a smallest unit to erase the NAND memory cells to store data in the memory sub-system 101, 161, or 163; and thus, an erasure operation cannot be performed in the memory sub-system 101, 161, or 163 to erase some of the pages in a block without easing the other pages in the block. A NAND memory cell is to be in an erased state in order to be programmed to store data. A page is a smallest unit to program memory cells to store data in the memory sub-system 101, 161, or 163; and thus, a data programming operation cannot be performed to program some memory cells in a page without programming other memory cells in the page.

At block 323, the method includes allocating a portion of random access memory cells (e.g., memory 173 or 175, host memory buffer 167 or 169) from a plurality of memory devices (e.g., 123; 141, 143, . . . , 145) connected to the computer express link fabric 121.

For example, the at least one processing device 117 of the memory sub-system 101, 161 or 163 can be configured to cache or buffer, in the portion of the random access memory cells (e.g., memory 173 or 175), and a portion of data (e.g., metadata 131 and/or user data 133) stored in the non-volatile memory cells 114.

For example, the portion of the data cached or buffered in the random access memory 112 allocated over the computer express link fabric 121 can include metadata 131, such as a portion of a logical to physical translation table 127 of a flash translation layer of the memory sub-system 101, 161, or 163.

At block 325, the method includes receiving, over the computer express link connection (e.g., 107 in FIG. 4), a storage access request (e.g., command 191) configured with a logical block addressing address 193 to identify a location in a storage space (e.g., 201 or 203) provided non-volatile memory cells (e.g., 114) of the memory sub-system (e.g., 101, 161, or 163).

At block 327, the method includes sending, over the computer express link connection (e.g., 107 in FIG. 4), one or more memory access requests into the computer express link fabric 121 to access the portion of the random access memory cells (e.g., memory 173 or 175, host memory buffer 167 or 169).

At block 329, the method includes processing the storage access request (e.g., command 191) received over the computer express link connection (e.g., 107 in FIG. 4) using the portion of the random access memory cells (e.g., memory 173 or 175, host memory buffer 167 or 169) accessed over the computer express link connection.

For example, the portion of the random access memory cells (e.g., memory 173 or 175, host memory buffer 167 or 169) can be allocated from more than one of the plurality of memory devices (e.g., 123; 141, 143, . . . , 145) connected to the computer express link fabric 121. Each of the plurality of memory devices (e.g., 123; 141, 143, . . . , 145) is connected via a separate CXL connection to the computer express link fabric 121.

For example, each of the one or more memory access requests can be configured with a memory address in a mapped memory space 171; and the computer express link fabric 121 is configured to map the memory address to an address of a subset of memory cells in one of the plurality of memory devices (e.g., 123; 141, 143, . . . , 145) connected to the computer express link fabric 121.

For example, the method of FIG. 15 can further include: storing at least a portion of a logical to physical translation table 127 of the memory sub-system (e.g., 101, 161, or 163) in the portion of the random access memory cells (e.g., host memory buffer 125, 167 or 169). The storage access request (e.g., command 191) can be processed via loading, from the portion of the logical to physical translation table 127 that is buffered/cached in the portion of the random access memory cells (e.g., host memory buffer 125, 167 or 169), a physical address 197 of non-volatile memory cells 114 (e.g., one or more pages of NAND memory cells) used to implement a storage space identified by the logical block addressing address 193.

For example, the method of FIG. 15 can further include: retrieving, over the computer express link connection (e.g., 107 in FIG. 4), the storage access request (e.g., command 191) from a submission queue (e.g., 181 or 185) configured in the portion of the random access memory cells (e.g., memory 173 or 175).

For example, the storage access request (e.g., command 191) can include an opcode for a write operation; and the method of FIG. 15 can further include: loading, over the computer express link connection (e.g., 107 in FIG. 4) and via memory access requests, data to be written via the write operation from the mapped memory space 171 at a memory address 195 identified in the storage access request (e.g., command 191).

For example, the storage access request (e.g., command 191) can include an opcode for a read operation; and the method of FIG. 15 can further include: storing, over the computer express link connection (e.g., 107 in FIG. 4) and via memory access requests, data retrieved via the read operation into the mapped memory space 171 at a memory address 195 identified in the storage access request (e.g., command 191).

For example, the storage access request (e.g., command 191) can be in accordance with a standard for non-volatile memory express (NVMe); and the one or more memory access requests can be in accordance with a standard for computer express link (CXL).

For example, the random access memory cells allocated over the CXL fabric 121 can be volatile; and the at least one processing device 117 of the memory sub-system 101, 161, or 163 can be further configured to maintain, in the non-volatile memory cells 114, a persistent copy of data cached or buffered in the portion of the random access memory cells allocated over the CXL fabric 121.

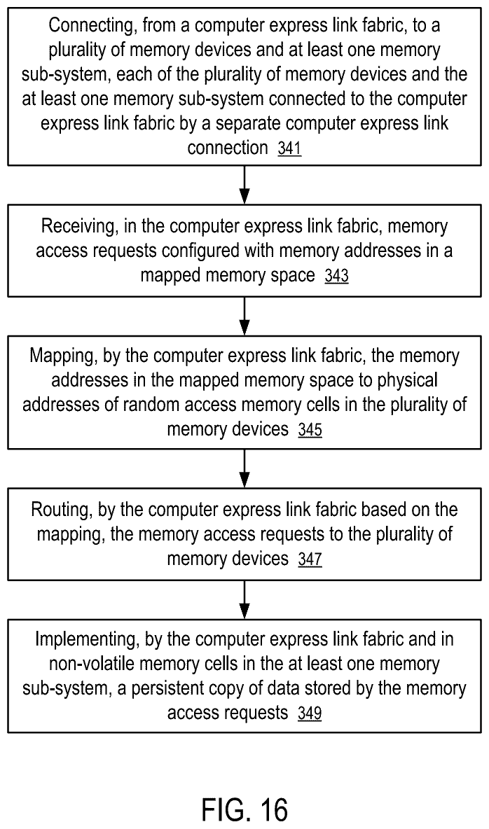

FIG. 16 shows a method to provide unified memory and storage services over computer express link fabric according to one embodiment. For example, the method of FIG. 16 can be implemented in the computing system 100 of FIG. 1 using the techniques discussed above in connection with FIG. 2 to FIG. 13, and optionally in combination with the methods of FIG. 14 and/or FIG. 15.

For example, the computing system 100 can have a computer express link fabric 121 configured to provide a unified memory and storage service using a plurality of memory devices (e.g., 123; 141, 143, . . . , 145) having random access memory cells and one or more memory sub-systems (e.g., 101, 161, 163) having non-volatile memory cells 114. The computer express link fabric 121 can have a plurality of computer express link switches, a plurality of point to point computer express link connections among the computer express link switches; and a controller 122 configured (e.g., via firmware or software) to provide the unified memory and storage service via its mapping 165 to route memory access requests over the fabric 121 to the memory devices (e.g., 123; 141, 143, . . . , 145).

For example, the controller 122 can map memory addresses in a mapped memory space 171 to physical addresses of random access memory cells of memory devices (e.g., 123; 141, 143, . . . , 145) connected to the computer express link fabric 121. The switches in the fabric 121 are configured to route memory access requests based on the mapping 165 implemented by the controller 122. The controller 122 can implement, in a storage space (e.g., 201, 203) of a memory sub-system (e.g., 161, 163) connected to the computer express link fabric 121 and having non-volatile memory cells 114, a persistent copy of data stored by memory access requests received in the computer express link fabric 121 and having memory addresses (e.g., 195) in the mapped memory space 171. Since the mapped memory space 171 is implemented using at least in part the storage space (e.g., 201, 203) of the memory sub-system (e.g., 161, 163), the mapped memory space 171 can be larger than a combined capacity of the random access memory cells of the memory devices (e.g., 123; 141, 143, . . . , 145). For example, the controller 122 can be configured to cache the storage space (e.g., 201 or 203) in the mapped memory space 171 a portion (e.g., 202 or 204) at a time based on memory access requests received in the computer express link fabric 121.

At block 341, the method of FIG. 16 includes connecting, from a computer express link fabric 121, to a plurality of memory devices (e.g., 123; 141, 143, . . . , 145) and at least one memory sub-system (e.g., 101, 161, 163). Each of the plurality of memory devices (e.g., 123; 141, 143, . . . , 145) and the at least one memory sub-system (e.g., 101, 161, 163) is connected to the computer express link fabric 121 by a separate point-to-point computer express link connection.

At block 343, the method includes receiving, in the computer express link fabric 121, memory access requests configured with memory addresses (e.g., 195) in a mapped memory space 171.

At block 345, the method includes mapping, by the computer express link fabric 121, the memory addresses (e.g., 195) in the mapped memory space 171 to physical addresses of random access memory cells in the plurality of memory devices (e.g., 123; 141, 143, . . . , 145).

At block 347, the method includes routing, by the computer express link fabric 121 based on the mapping 165, the memory access requests to the plurality of memory devices (e.g., 123; 141, 143, . . . , 145).

At block 349, the method includes implementing, by the computer express link fabric 121 and in non-volatile memory cells 114 in the at least one memory sub-system (e.g., 101, 161, 163), a persistent copy of data stored by the memory access requests.

For example, the method can further include: monitoring, by the computer express link fabric 121, traffics in the computer express link fabric 121; and adjusting, by the computer express link fabric 121 and based on the monitoring, the mapping 165.

For example, the method can further include: allocating a first portion of the mapped memory space 171 as a host memory buffer (e.g., 167 or 169) of the memory sub-system (e.g., 161 or 163).

For example, the method can further include: allocating a second portion of the mapped memory space 171 as a cyclic buffer to host a submission queue (e.g., 181 or 185) shared between a controller 122 of the computer express link fabric 121 and the memory sub-system (e.g., 161 or 163). For example, the submission queue (e.g., 181 or 185) can be reserved exclusively for the controller 122 to send storage access requests (e.g., command 191) to the memory sub-system (e.g., 101, 161, or 163).

For example, the method can further include: mapping a third portion of the mapped memory space 171 to cache or buffer a portion of a storage space (e.g., 201 or 203) implemented using the non-volatile memory cells 114 in the memory sub-system (e.g., 161 or 163).

For example, the method can further include, in response to a memory access request received in the computer express link fabric 121 and having a memory address in the third portion of the mapping memory space 171: allocating a subset of the random access memory cells in the plurality of memory devices (e.g., 123; 141, 143, . . . , 145); and remapping the third portion to the subset of the random access memory cells in the plurality of memory devices (e.g., 123; 141, 143, . . . , 145).

For example, the remapping can include entering, by the controller 122 of the computer express link fabric 121 and into the submission queue (e.g., 181 or 185), a storage access request (e.g., command 191) containing a read opcode. The completion of processing the storage access request (e.g., command 191) in the memory sub-system (e.g., 101, 161, or 163) causes the data 177 in the cached portion (e.g., 202 or 204) of the storage space (e.g., 201 or 203) of the memory sub-system (e.g., 161 or 163) to be cached or buffered at the memory address 195 identified in the storage access request (e.g., command 191). After the completion of processing the storage access request (e.g., command 191) in the memory sub-system (e.g., 101, 161, or 163), the fabric 121 routes memory address requests addressing the third portion of the mapping memory space 171 to the cached/buffered portion (e.g., 202 or 204) in the random access memory 112 of the memory devices (e.g., 123; 141, 143, . . . , 145).

For example, the subset of the random access memory cells allocated to implement the cached/buffered portion (e.g., 202 or 204) can be previously allocated to implement another portion of the mapped memory space 171. To free up the subset of the random access memory cells, the controller 122 of the computer express link fabric 121 can enter into the submission queue (e.g., 181 or 185), a storage access request containing a write opcode to write data from the subset of the random access memory cells into the non-volatile memory cells 114 in the memory sub-system (e.g., 161 or 163); and then, the controller 122 of the computer express link fabric 121, a fourth portion of the mapped memory space 171, previously implemented using the subset, to the storage space (e.g., 201 or 203) of the memory sub-system (e.g., 161 or 163).

For example, the controller 122 can be configured to dynamically adjust, based on memory access requests received in the computer express link fabric 121, the mapping 165 of the memory addresses in the mapped memory space 171 to the physical addresses of the random access memory cells in the memory devices (e.g., 123; 141, 143, . . . , 145). For example, based on memory access requests received in the computer express link fabric 121, the controller 122 can select a portion of the storage space (e.g., 201 or 203) for caching in the mapped memory space 171.

A computer express link fabric 121 can have a plurality of computer express link switches inter-connected by a plurality of computer express link connections. One or more switches in the fabric 121 can be connected to one or more other switches for multi-level switching. A controller 122 (e.g., fabric manager) can be used to manage memory allocation and to manage routing memory access requests, through the fabric 121, to memory devices (e.g., 123, 141, 143, . . . , 145). Random access memory cells in the memory devices (e.g., 123, 141, 143, . . . , 145) are connected via the fabric 121 to provide the random access memory 112.

Due to the large design space of CXL fabrics (e.g., 121), which can be composed of unlimited topologies, it is a challenge to design a set of policies for memory allocation and for routing memory access requests to optimize the performance of the random access memory 112. It is a challenge to design policies that can perform well for various applications that use the random access memory 112 over the computer express link fabric 121.

To ensure quality of service (QoS) in accessing the random access memory 112 over the computer express link fabric 121, a host device (e.g., 118, 128, or 129) accessing the random access memory 112 over the computer express link fabric 121 can specify a worst-case latency for accessing the random access memory 112.

Due to network effects of dynamically changing workloads of memory access patterns and the resulting network traffic in the fabric 121, latency in accessing the random access memory 112 over the fabric 121 can change non-deterministically.

For example, the latency can change when the fabric topology (e.g., the way in which devices are interconnected) changes. Further, the latency can change when the run-time memory traffic pattern (e.g., the access patterns of hosts/applications using the random access memory 112 over the fabric 121) changes. Further, the latency can change when the policies implemented in the fabric 121 to handle memory allocation and routing change.

At least some aspects of the present disclosure address the above and other deficiencies and challenges by implementing intelligent management of memory allocation and routing policies using techniques of reinforcement learning (e.g., Q-learning).

For example, reinforcement learning techniques can be used to learn the memory allocation and routing policies that are best for the current operating conditions and workloads of the fabric 121. The controller 122 can use reinforcement learning (e.g., Q-learning) to learn from actions taken within the computer express link fabric 121.

In some implementations, an allocation and routing agent is configured in each computer express link switch to optimize its operations; and the collection of agents running in the switches of the fabric 121 can collectively optimize the operations of the fabric 121 as a whole.

For example, the agent in a computer express link switch can be configured to make decisions of routing a memory access request from one port to another in a way such that the latency for responding to the request is no worse than a threshold (e.g., a worst-case latency as specified by a host device). When there are multiple options to route the memory access request under the constraint of the threshold, the agent can select an option that is expected to maximize rewards as determined from reinforcement learning (e.g., Q-learning).

For example, the agent in a computer express link switch can be configured to make decisions of mapping a memory address to a unit of memory cells in a memory device (e.g., 141, 143, . . . , or 145) such that the latency for responding to a request to access the memory address is no worse than a threshold (e.g., a worst-case latency as specified by a host device). When there are multiple options to map the memory address under the constraint of the threshold, the agent can select an option that is expected to maximize rewards as determined from reinforcement learning (e.g., Q-learning).

For example, the rewards for routing memory access requests can be configured based on measurements of the latency of processing memory access requests as a result of using different options/policies under different conditions. The agent in a computer express link switch can be configured to iteratively determine rewards that can be obtained by using different options/policies at different conditions through reinforcement learning (e.g., Q-learning). Subsequently, the agent can process its received memory access requests by using the options that maximize rewards and thus minimize the overall latency of responding to the requests.

For example, the agent in computer express link switch can be configured to use a reinforcement learning technique (e.g., Q-learning) to select a policy (or option) (e.g., from a plurality of policies or options that do not violate the worst-case latency requirement in routing requests and/or allocating memory) for a given state of the switch. The selection is made to maximize rewards that are configured such that maximizing rewards corresponding to minimizing latency. For example, for optimization of routing decisions, rewards to the agent can be configured based on reduction in the immediate latency of link traversal handled by the switch. For example, for optimization of memory allocation decisions, rewards to the agent can be configured based on reduction in the average latency for responding to memory access requests handled via the switch during a period of time.

For example, the agent in a computer express link switch can store a reward table having a plurality of rows corresponding respectively to a plurality of ports in the switch. The table can have a plurality of columns corresponding respectively to a plurality of possible states of the switch. At a given state, the corresponding value in the reward table at a row representing a port of the switch and a column corresponding to the current state of the switch provides the expected reward for using the port to perform routing or allocation.

From the column of the reward table corresponding to the current state of the switch, the agent can select a row that has the largest expected reward and use the port, represented by the row having the largest expected reward, in routing or allocation.

After performing the routing or allocation using the selected port, the state of the switch can change to a next state represented by another column in the reward table. The agent can determine the maximum reward that can be expected for the next state according to the current reward table. After measuring the actual reward obtained from performing the routing or allocation using the selected port, the agent can update the reward in the current state/column using the weighted average of the reward as in the current table, and the sum of the reward and a discount factor multiplying the expected maximum reward for the next state. After a number of explorative decisions, the content of the reward table can converge and be used to cause the agent to select ports for maximized rewards at various states of the switch. The reward table can continue to adapt to the recent operating patterns of the memory system as a whole; and the technique does not require a model of the environment of the computer express link switch.

Alternatively, a centralized module can use the reinforcement learning technique to select the path of routing or allocation through the computer express link switches in the fabric 121 and instruct the respective switches to process the memory access requests accordingly.

For example, the controller 122 of the computer express link (CXL) fabric 121 (e.g., as in FIG. 5 to FIG. 13) can be configured to manage how communications are propagated through switches in the fabric 121 and interconnecting links to memory devices (e.g., 123; 141, 143, . . . , 145). The controller 122 can use the reinforcement learning (RL) techniques to adapt its usages of routing policies to maximize rewards that are configured to minimize latency.

For example, the controller 122 of the computer express link (CXL) fabric 121 (e.g., as in FIG. 5 to FIG. 13) can be configured to manage how data is placed within the set of memory devices (e.g., 123; 141, 143, . . . , 145) and/or memory sub-systems (e.g., 101; 161, . . . , 163) to minimize average latency of access in a period of time. The data placement can be adjusted periodically, in view workload and communication delays in the fabric 121, to maximize rewards.

In some implementations, the controller 122 of the computer express link (CXL) fabric 121 (e.g., as in FIG. 5 to FIG. 13) is implemented via a set of routing and allocation agents distributed in the computer express link (CXL) switches in the fabric 121. Each switch can run an agent to independently optimize its policies for routing and/or data placement, in view of traffic visible to the switch. The collection of agents can collectively optimize the operation of the computer express link fabric 121 via reinforcement learning.

Frequently accessed data can be referred to as hot; and infrequently accessed data can be referred to as cold. In general, the data in the random access memory 112 connected via the computer express link fabric 121 can have some hot data, some cold data, and other data having access temperatures between hot and cold.

Cold data in the random access memory 112 can take up the resources (e.g., random access memory cells) in the memory devices (e.g., 123; 141, 143, . . . , 145) connected to the fabric 121, making the resources unavailable for improving the performance of the fabric 121 in provisioning of the random access memory 112 (e.g., accessed via memory addresses (e.g., 213) in the mapped memory space 171) and/or limiting the size of the memory space 171. Cold data can be compressed to free up resources that can be used to improve the performance of the random access memory 112 in servicing the computing system 100.

In at least some embodiments, the decision to compress cold data and decompress data that may become hot is offloaded to the computer express link fabric 121 and/or its controller 122.

For example, the controller 122 of the computer express link fabric 121 can use its visibility to the memory access traffic going through the fabric 121 to intelligently identify and compress cold data and to predictively decompress data that is expected to become hot soon.

For example, the controller 122 can be configured not only to determine whether to compress any data in the random access memory 112 and to select a portion of the data in the random access memory 112 for compression, but also to select a compression technique, from a plurality of compression techniques, to compress a selected portion of the data. The controller 122 can include a reinforcement learning module configured to learn (e.g., using a Q-learning technique) the optimal or near-optimal options for implementing data compression in connection with management of data placement and/or management of routing of memory access requests.

In some situations, it is not necessary to compress any data in the random access memory 112. For example, in some instances, only a small portion of the pool of random access memory cells of the memory devices 141, 143, . . . , 145 is currently being allocated to implement portions of the mapped memory space 171 that are currently being used by the computing system 100. In such situations, it is not necessary to compress any data in the random access memory 112. Since there are sufficient free random access memory cells available for allocation to implement further portions of the mapped memory space 171, compressing data in the random access memory 112 to free up some random access memory cells would not improve the performance of the computing system 100, but can degrade the system performance in some cases (e.g., when the compressed data is being addressed for access). When the free random access memory cells in the memory devices 141, 143, . . . , 145 are sufficient to implement portions of the mapped memory space 171 that will be used by the computing system 100 in a next period of operation without compression, compressing data in the random access memory 112 can potentially degrade the performance of the computing system 100 in its operation during the next period of time.

When it is not necessary to compress data, the controller 122 of the computer express link fabric 121 can monitor the memory access traffic in the fabric 121 to train a compression model (e.g., via a reinforcement learning technique) for selecting options involved in data compression, while actual data compression operations can be paused. For example, the selection of options can be trained to maximize rewards in a combined goal of reducing computation and maximizing memory that can be freed for a longest duration.

Optionally, the controller 122 of the computer express link fabric 121 can monitor the memory access traffic in the fabric 121 to train a decompression model (e.g., via a reinforcement learning technique) for selecting options involved in data deqcompression, while actual data decompression operations can be paused.

For example, the controller 122 can train the compression model (and/or the decompression model) based on reinforcement learning states configured according to age (e.g., time since memory allocation to implement a portion of the mapped memory space 171), access frequency (e.g., rate of accessing the portion of the mapped memory space 171 using the allocated memory), last access (e.g., lapsed time since last accessing the portion of the mapped memory space 171), dominant access type (e.g., whether the access to the portion of the mapped memory space 171 is primarily read or write), etc. Optionally, the selection can be further based on metadata provided in the memory access requests and/or responses that are indicative of the application context of the of the memory accesses.

When the utilization rate of the random access memory cells of the memory devices 141, 143, . . . , 145 is above a threshold, the controller 122 can use the compression model to select data for compression, in anticipation of an increased demand for random access memory cells that is above the amount of random access memory cells in the memory devices 141, 143, . . . , 145 connected to the fabric 121.

When the utilization rate of the random access memory cells of the memory devices 141, 143, . . . , 145 is above the threshold, the controller 122 can optionally further train the compression model for selections of options for implement data compression. The training can be configured to optimize the performance of the random access memory 112 accessed via the computer express link fabric 121 (e.g., in a way similar to the optimization of data placement). Storage of data in a compressed form, in the memory devices 141, 143, . . . , 145 or in the memory sub-systems 161, . . . , 163, and compressed using different compression techniques, can be considered different options for data placement implemented via the mapping 165.

As an option, the compressed data can be kept in a reduced amount of random access memory cells allocated from the memory devices 141, 143, . . . , 145. As another option, the compressed can be swapped to the storage space (e.g., 201) of a memory sub-system 161 to free up even more random access memory cells of the memory devices 141, 143, . . . , 145 that can be allocated to hold hot data.

In general, storage of data of a portion (e.g., 152) of the mapped memory space 171 in an uncompressed form in the memory devices 141, 143, . . . , 145 or in the memory sub-systems 161, . . . , 163, or in a form compressed using one of a plurality of predetermined compression techniques, can be considered different options for using the mapping 165 to implement data placement for the portion (e.g., 152) of the mapped memory space 171. The controller 122 can use a reinforcement learning technique (e.g., Q-learning) to optimize the mapping 165 based at least in part on deciding whether to swap the compressed data out to a storage space (e.g., 201), or to another memory device.

The controller 122 can use the compression model to optimize the selection of a compression technique, from a plurality of compression techniques, to compress the selected data.

There are multiple compression techniques (e.g., LZ77, LZ4, Lempel-Ziv-Markov chain algorithm (LZMA), deflate implemented in zlib) known in the field. The compression techniques have different characteristics, such as different compression ratios (e.g., moderate, low-moderate, moderate-high, high), different speeds (e.g., high, very high, moderate, moderate-low), etc. Applying different compression techniques to different data can lead to different rewards/tradeoff in reducing computation cost, harvesting memory saving, maximizing the time in which the data can stay in a compressed form, etc.

For example, compressing a piece of data using a fast compression technique can maximize the time during which the data can be in the compressed form before being decompressed for access. However, a fast compression technique can have a lower compression ratio when compared with the slow compression, which can decrease the amount of memory saving that can be achieved via compression.

A reinforcement learning technique can be used to learn an optimal or near-optimal selection of a compression technique for compressing data in a portion of the random access memory 112.

For example, the rewards of reinforcement learning can be configured as a function of a performance level indicator (e.g., average latency of accessing the random access memory 112 over the fabric) such that maximizing the rewards can lead to the selection of options in data compression to optimize the overall performance level of the random access memory 112 in a period of time. Alternatively, or in combination, the rewards can be a function of the computation cost of the performing the compression and/or the number of clock cycles in which the compressed data is not accessed after the compression. An increased number of clock cycles of no access can be given an increased reward.

When an incoming memory access request has a memory address that is within a portion of the mapped memory space 171 implemented with compression, the computer express link fabric 121 can perform decompression on demand and route the memory access request to the random access memory cells allocated to hold the decompressed data. The decompression operation can impact the performance of the random access memory 112 accessed via the fabric 121, while the memory saving achieved during the period in which the data is in a compressed form can be used to improve the performance of the random access memory 112. A reinforcement learning technique (e.g., Q-learning) can be used to optimize the decisions to implement the mapping 165 for different portions of the space 171 with or without compression.

The controller 122 can train a decompression model to select data for predictive decompression before receiving an incoming memory access request that addresses the compressed data. The decompression model can be trained to maximize the rewards configured based on a performance level indicator of the computer express link fabric 121 in providing access to the random access memory 112 (e.g., in a way similar to the optimization of options for the mapping 165). Alternatively, or in combination, the decompression rewards can be a function of the computation cost of the performing the decompression and/or the number of clock cycles in which the decompressed data is accessed after the decompression.

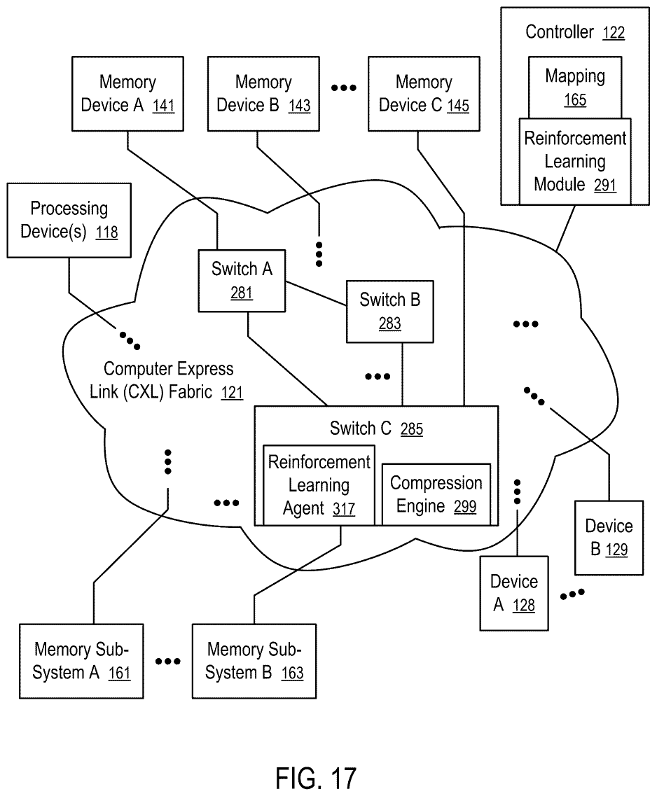

FIG. 17 shows a computer express link fabric configured to manage routing of memory access requests and data placement with compression using reinforcement learning according to one embodiment. For example, the computer express link fabric 121 discussed above in connection with FIG. 1 to FIG. 16 can be implemented as in FIG. 17.

In FIG. 17, the computer express link fabric 121 includes a plurality computer express link switches (e.g., 281, 283, 285). Each of the switches (e.g., 281, 283, or 285) has a plurality of ports connected to separate computer express link connections. A switch (e.g., 281, 283, or 285) is configured to route a memory access request or response received at one port to another. A computer express link connection in the fabric 121 can connect a port of one switch to a port of another switch, or to a memory device (e.g., 141, 143, or 145), or to a memory sub-system (e.g., 161, or 163), or to a processing device 118 (e.g., a CPU, a CPU core, an SoC) or another device (e.g., 128 or 129, such as a GPU, a GPU core, an AI accelerator).

A controller 122 of the fabric 121 can control the switches (e.g., 281, 283, or 285) of the fabric 121 to implement the mapping 165 for routing memory access requests having addresses in the mapped memory space 171 to addresses of random access memory cells in the memory devices 141, 143, . . . , 145.

The controller 122 can include a reinforcement learning module 291 to optimize the mapping 165 for reduced latency in accessing the random access memory 112 over the fabric 121.

For example, the reinforcement learning module 291 can be implemented using a Q-learning technique to determine the routing of one or more memory access requests through the switches in the fabric, in view of the current states of the switches, to minimize the overall latency of the one or more memory access requests. For example, the minimization can be performed to ensure that the latency of each of the memory access requests meeting the worst-case latency requirement from a requesting device (e.g., 118, 128, or 129).

For example, the reinforcement learning module 291 can be implemented using a Q-learning technique to determine the mapping 165 to minimize average latency of memory access requests in a recent period of time. For example, the reinforcement learning module 291 can periodically adjust the mapping 165 using a Q-learning technique to maximize the reward for reducing average latency in a time period.

In some implementations, the reinforcement learning module 291 is configured on a centralized device in communication with the switches 281, 283, . . . , 285 in the fabric 121. In other implementations, the reinforcement learning module 291 is implemented via a set of reinforcement learning agents (e.g., 317) each running in one of the switches 281, 283, . . . , 285 to optimize the operations of the respective switch (e.g., 285) in which the agent (e.g., 317) is running. The agents (e.g., 317) are configured to make separate and independent routing decisions. The agents (e.g., 317) can collectively optimize the fabric 121 as a whole over time by each optimizing the switch (e.g., 285) in which the agent (e.g., 317) is running.

The use of agents (e.g., 317) distributed in the switches (e.g., 285) can reduce the size of the state spaces of the reward tables to be explored and determined by each agent (e.g., 317). Thus, the efficiency of the agents (e.g., 317) can be improved with reduced resource usages. However, independently exploring the states of switches separately by the agents can reduce the convergence rates of the reward tables.

The switches (e.g., 285) in the fabric 121 can be configured with compression engines (e.g., 299) to optionally compress data placed in the memory devices 141, 143, . . . , 145 and to decompress data for placement in the memory devices 141, 143, . . . , 145.

For example, a compression engine 299 implemented in a switch 285 is capable of performing compression/decompression in a plurality of formats (LZ77, LZ4, Lempel-Ziv-Markov chain algorithm (LZMA), deflate implemented in zlib). The reinforcement learning module 291 and/or the reinforcement learning agent 317 can determine whether to compress any data in a memory device (e.g., 145) connected directly to a port of the switch 285 using a computer express link connection without an intervening switch between the switch 285 and the memory device (e.g., 145). In response to a decision to compress a portion of data in the memory device 145 to free up random access memory cells for implementing a further portion of the mapped memory space 171, the switch 285 can use its compression engine 299 to compress data in a format selected by the reinforcement learning module 291 and/or the reinforcement learning agent 317. The compressed data can be placed according to the mapping 165 in the memory device 145 or another memory device (e.g., 141 or 143), or a memory sub-system (e.g., 161 or 163).

Similarly, the reinforcement learning module 291 and/or the reinforcement learning agent 317 can decide to place compressed data in a decompressed form in a memory device (e.g., 145). In response to such a decision, the compression engine 299 can retrieve the compressed data (e.g., from a memory sub-system (e.g., 161 or 163) or a memory device (e.g., 141, 143, or 145)), perform the decompression according to the compression format of the compressed data, and store the decompressed data into the memory device (e.g., 145).

Through the intelligent use of compression/decompression, the computer express link fabric 121 can over-provision memory/storage capacity via dynamic mapping 165 of memory addresses used by the host devices (e.g., 118, 128, 129) to physical memory addresses in the memory devices (e.g., 123; 141, 143, . . . , 145).

The controller 122 of the computer express link fabric 121 (e.g., as discussed above in connection with FIG. 1 to FIG. 16) can monitor the changing memory/storage usage patterns. The reinforcement learning module 291 (e.g., implemented in a centralized device, or via a set of reinforcement learning agents (e.g., 317) distributed in the switches 281, 283, . . . , 285 of the fabric 121) can learn (e.g., via reinforcement learning, such as Q-learning) to identify best options to select cold data for compression, to select compression formats for performing compression, and to offload the compressed data to other memory devices (e.g., 141) and/or to memory sub-systems (e.g., 161). Through reinforcement learning the fabric 121 can adjust data placement and compression for improved performance and capacity.

Intelligent selection of data for compression (e.g., through reinforcement learning) can reduce unnecessary operations (e.g., compression) for improved energy efficiency.

Accessing compressed data can cause delay. When cold data is compressed and/or offloaded to a memory sub-system (e.g., 161) and/or a slower memory, it can take time to decompress the data to facilitate access.

The controller 122 of the fabric 121 can monitor the changing memory/storage usage patterns and learn (e.g., via reinforcement learning) to select portions of data that are currently in a compressed format for predictive decompression before the data is being accessed.

Decompression can increase the demand for random access memory cells in the memory devices (e.g., 123; 141, 143, . . . , 145); and compression of other data can free up random access memory cells to hold the decompressed data. The reinforcement learning module 291 and/or the reinforcement learning agents (e.g., 317) can learn to selection options for compression and decompression to maximize a performance level indicator of the random access memory 112 provided via the fabric 121. The performance level indicator can be based on the average memory access latency in a period of time, the energy consumption of the memory and storage resources connected by the fabric 121, and/or other aspects of the random access memory 112.

Intelligent selection of data for decompression (e.g., through reinforcement learning) can reduce latency penalty in initially accessing the compressed data while reducing unnecessary operations (e.g., the decompressed data is not used in a period of time).

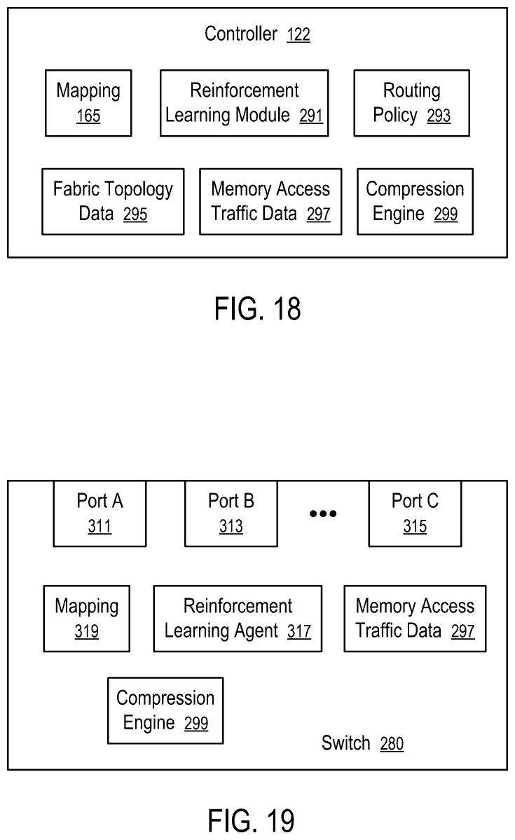

FIG. 18 shows a controller of a computer express link fabric according to one embodiment. For example, the controller 122 of the computer express link (CXL) fabric 121 (e.g., as in FIG. 5 to FIG. 13 and FIG. 17) can be implemented in a way as shown in FIG. 18.

In FIG. 18, the controller 122 stores data specifying the mapping 165 between memory addresses in the mapped memory space 171 and memory addresses in memory devices 141, 143, . . . , 145 connected to the fabric 121. Using the mapping 165 the controller 122 can instruct the switches 281, 283, . . . , 285 in the fabric 121 to route memory access requests from devices (e.g., 118, 128, . . . , 129) to the memory devices 141, 143, . . . , 145 that implement the respective memory locations represented by the memory addresses in the mapped memory space 171.

In general, there can be multiple paths/options for routing a memory access request through the fabric 121. The controller 122 can store one or more routing policies 293 that can be used to select path. The selection can be made based on fabric topology data 295 specifying how switches are interconnected, and memory access traffic data 297 specifying memory access requests currently being routed through the fabric 121.

The controller 122 can include a reinforcement learning module 291 to control the use of the routing policy 293 in routing memory access requests through the fabric 121 and/or to adjust the mapping 165 for improved average performance of the random access memory 112 provided over the fabric 121 in a period of time.

For example, the reinforcement learning module 291 can be implemented using a Q-learning technique to maximize the reward in applying the routing policy 293 and/or adjusting the mapping 165.

For example, to optimize the application of the routing policies 293, the reinforcement learning module 291 can maintain a table of expected rewards for a set of states of the fabric 121 (e.g., represented by the memory access traffic data 297) and a set of options to apply the routing policies 293. When the fabric 121 is in a particular state, among the set of states, the reinforcement learning module 291 can select one of the options (e.g., the option that provides the highest reward according to the current reward table, or a random selection) and measure the actual reward (e.g., represented by a performance of the fabric 121 in routing the memory access request currently being routed). The reinforcement learning module 291 can update the reward table based on a weighted average of the current reward value in the table for the state and the selected option, a combination of the measured reward and the maximum expected reward for the next state, where the next state is a result of the applying the selected option at the current state. The maximum expected reward for the next state is determined from the current reward table for the next state of the fabric 121 with a best option selected to route the next memory access request according to the current reward table. After a number of iterations for exploration, the values in the reward table can converge; and the reinforcement learning module 291 can select the option that provides the highest reward according to the current state of the fabric 121 for optimal or near optimal performance. The reward table can be further updated to adapt to the changing pattern of memory access of the computing system 100.

For example, to optimize the adjustment of the mapping 165, the reinforcement learning module 291 can maintain a table of expected rewards for a set of states of the random access memory 112 (e.g., represented by the current mapping 165 and statistics of the memory access traffic data 297 over a period of time) and a set of options to change the mapping 165. After each period of a predetermined time interval, the reinforcement learning module 291 can select and apply an option to change the mapping and measure the reward for the change (e.g., represented by an average performance of the fabric 121 in routing the memory access requests during the next period of the predetermined interval). Using the Q-learning technique, the reward table can be updated. After a number of iterations for exploration, the values in the reward table can converge; and the reinforcement learning module 291 can select the option that provides the highest reward according to the current state of the random access memory 112 for optimal or near optimal performance in the next period of the predetermined time interval. The reward table can be further updated to adapt to the changing pattern of memory access of the computing system 100.

In general, as the size of the fabric 121 grows, the number of possible states of the fabric 121 and/or the number of possible states of the random access memory 112 can grow dramatically. To simplify the operations of Q-learning, it can be advantages to implement the controller 122 via a set of agents (e.g., 317) distributed in the switches (e.g., 281, 283, . . . , 285) in the fabric 121. Each of the agents (e.g., 317) can be configured to optimize the operations of the switch (e.g., 285) in which the agent (e.g., 317) is running based on the states of the switch (e.g., 285) and/or the states of the random access memory 112 as seen from the point of view of the switch (e.g., 285). For example, each switch (e.g., 281, 283 or 285) can be implemented in a way as illustrated in FIG. 19.

The controller 122 can have one or more compression engines 299 to compress data moved from one portion of random access memory 112 to another (or to the storage space 201 or 203 of a memory sub-system 161 or 163). The compression engines 299 can also be used to decompress data moved from one portion of random access memory 112 (or the storage space 201 or 203 of a memory sub-system 161 or 163) to another portion of the random access memory 112.

The reinforcement learning module 291 can learn to best select data for compression and decompression, and to best select compression formats/techniques for the compression of selected data, as further discussed below.

FIG. 19 shows a computer express link fabric switch 280 according to one embodiment. For example, the computer express link fabric switch 280 of FIG. 19 can be used to implement one or more, or each, of the switches (e.g., 281, 283 or 285) in the computer express link fabric 121 discussed above in connection with FIG. 1 to FIG. 18.

The computer express link fabric switch 280 can have a plurality of ports 311, 313, . . . , and 315. Options to route a memory access request by the switch 280 correspond to the ports 311, 313, . . . , and 315.

A port (e.g., 311) of the switch 280 can be connected to a memory device (e.g., 141). Thus, such a portion is a device-connected port (e.g., 311). When a memory address in the mapped memory space 171 is mapped to the memory device (e.g., 141, 143, or 145) attached to the port (e.g., 311, 313, or 315), the mapping 319 stored in the switch 280 indicates the mapping between the memory address in the mapped memory space 171 and a physical address in the memory device (e.g., 141, 143, or 145). Thus, the mapping 319 can be used to decide the routing of memory access requests having the memory address to the port (e.g., 311, 313, or 315).

A port (e.g., 315) of the switch 280 can be connected to another switch (e.g., 285). Thus, the port (e.g., 315) is a switch-connected port (e.g., 315). In some instances, the mapping 319 stored in the switch 280 does not specify that a memory address in the mapped memory space 171 is mapped to a memory device (e.g., 141, 143, or 145) that is attached directly to a device-connected port of the switch 280.

Thus, the switch 280 can route a memory access request for such a memory address to the switch-connected port (e.g., 315) that is connected to another switch (e.g., 285). In general, the switch 280 can have the options to route such a memory access request to more than one switch-connected port (e.g., 315) of the switch 280.

The reinforcement learning agent 317 running in the switch 280 can organize the reward table of Q-learning in a plurality of rows corresponding respectively to the plurality of ports 311, 313, . . . , and 315 as the routing options. An incoming memory access request can be routed to one of the ports as a routine option.

The reinforcement learning agent 317 can store memory access traffic data 297 as seen in the switch 280 to represent the state of the switch 280 in routing an incoming memory access request received in one of the ports 311, 313, . . . , and 315.

For example, the state of the switch 280 can be constructed to identify a subset of the ports 311, 313, . . . , and 315 having incoming requests, and a subset of the ports 311, 313, . . . , and 315 having outgoing requests that have not yet received responses.

Optionally, the switch 280 can have a buffer for temporarily holding a number of incoming requests for dispatching through one of the ports 311, 313, . . . , and 315; and the state of the switch 280 can be constructed to further indicate the status of the buffered incoming requests.

Optionally, the switch 280 can have a buffer for temporarily holding a number of incoming responses for dispatching through one of the ports 311, 313, . . . , and 315; and the state of the switch 280 can be constructed to further indicate the status of the buffered incoming responses.

The switch 280 can be in one of a plurality of different states, where the current state of the switch 280 is identified based on the memory access traffic data 297; and the reward table maintained by the reinforcement learning agent 317 can include a plurality of columns corresponding respectively to the plurality of states. After a number of explorations based on Q-learning, the reward values in the reward table can converge and be used to make routing selections for improved performance.

The switch 280 can have a compression engine 299 that is capable of performing compression/decompression using any of a plurality of compression techniques (e.g., LZ77, LZ4, Lempel-Ziv-Markov chain algorithm (LZMA), deflate implemented in zlib). The reinforcement learning agent 317 can learn to select one of compression techniques to maximize the rewards/benefits for compressing the data in a portion of the mapped memory space 171.

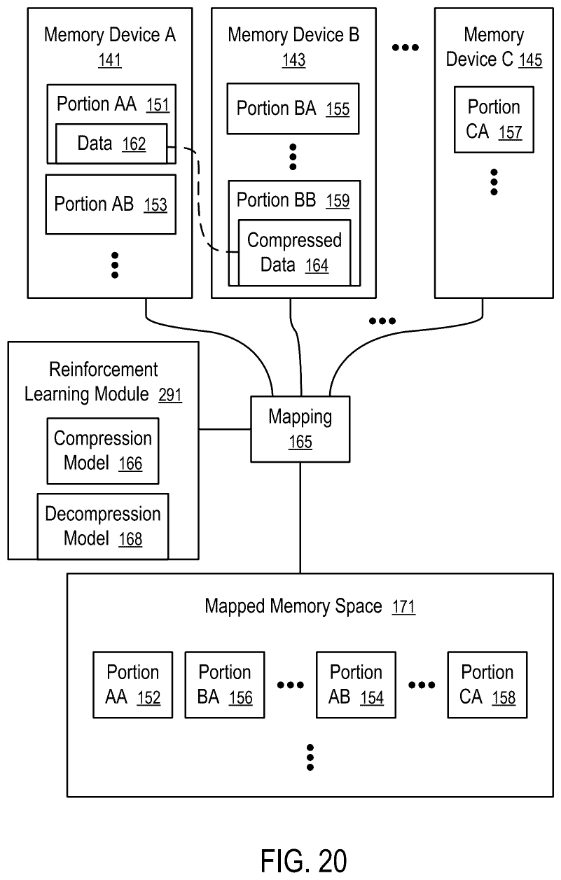

Periodically, the reinforcement learning agent 317 can explore changes in the mapping 319. For example, a region of memory addresses in the mapped memory space 171 previously mapped to a memory device (e.g., 141) attached to a device-connected port (e.g., 311) can be remapped to another memory device (e.g., 143) attached to another device-connected port (e.g., 313), or to one or more memory devices (e.g., 145) attached via one or more other switches (e.g., 283) to a switch-connected port (e.g., 315) of the switch 280. Using the technique of Q-learning, the reinforcement learning agent 317 can optimize the mapping 319 to reduce or minimize average routing delays through maximizing rewards using a reward table, as further discussed below in connection with FIG. 20 to FIG. 23.

In adjusting the mapping 319, the reinforcement learning agent 317 can optionally explore the options to compress data at selected portions of the mapped memory space 171 and/or the options to predictively decompress data of selected portions of the mapped memory space 171.

For example, during a time period of operations of the computing system 100, the switch 280 can receive a memory access request that causes the allocation of random access memory cells from the memory devices 141, 143, . . . , 145 to implement a portion of the mapped memory space 171. When there are insufficient free random access memory cells in the memory devices 141, 143, . . . , 145, the switch 280 can swap a portion of cold data from the memory devices 141, 143, . . . , 145 to the memory sub-systems 161, . . . , 163 to free up the random access memory cells previously used to the portion of cold data being swapped out. The swapping operation can degrade the performance of the random access memory 112 accessed via the fabric during the previous time interval. Optionally, the switch 280 can predicatively/preemptively select a portion of cold data for compression to increase the amount of free random access memory cells that can be used to implement the portions of the mapped memory space 171. Increasing the available amount of free random access memory cells can reduce or eliminate the performance impact on the swapping operations. However, the compression operations can have an impact on the performance of the random access memory 112. The use of different compression techniques can lead to different cost benefit tradeoff. In general, it is difficult to design a set of predetermined rules to achieve optimal or near-optimal results.

The reinforcement learning agent 317 can use periodical adjustments to learn the expected rewards for improving the system performance when various data placement options are used. Such data placement options can include the options of predictive compression implemented using options of different compression techniques. Such data placement options can include the options of predictive decompression.

After a number of iterations, the reward values in the model of the reinforcement learning agent 317 can converge; and the reinforcement learning agent 317 can use the options corresponding to largest expected reward values to select and implement options that modify the mapping 165. For example, a selected option can include compression a portion of the data in a memory device (e.g., 141) using a selected compression technique, decompression a portion of data into the memory device (e.g., 141), and/or offloading the compressed data to another memory device (e.g., 143) or a memory sub-system (e.g., 161) FIG. 20 shows a reinforcement learning module configured to optimize mapping from a mapped memory space to random access memories in memory devices connected to a computer express link fabric according to one embodiment. For example, the reinforcement learning module 291 in the controller 122 of FIG. 18 can be implemented in a way as illustrated in FIG. 20 to optimize mapping 165.

In FIG. 20, a mapped memory space 171 has a plurality of portions (e.g., 152, 156, . . . , 154, . . . , 158). The mapping 165 configured in the controller 122 of a computer express link fabric 121 (e.g., as discussed above in connection with FIG. 1 to FIG. 17) can implement the portions (e.g., 152) using portions of random access memory cells allocated from the memory devices 141, 143, . . . , 145 connected to the computer express link fabric 121.

For example, the portion 152 in the space 171 can be implemented using a portion 151 allocated from memory device 141; the portion 154 in the space 171 can be implemented using a portion 153 allocated from the memory device 141; the portion 156 in the space 171 can be implemented using a portion 155 allocated from the memory device 143; and the portion 158 in the space 171 can be implemented using a portion 157 allocated from the memory device 145.

For example, the portions 152 and 156 in the mapped memory space 171 can be allocated as a host memory buffer 167 for a memory sub-system 161, where the host memory buffer 167 is physically implemented using the portion 151 allocated from the memory device 141 and the portion 155 allocated from the memory device 143, as in FIG. 5.

For example, when the fabric 121 receives a memory access request having a memory address in the portion 152 of the space 171, the fabric 121 causes the switches (e.g., 281, 283, . . . , 285) in the fabric 121 to route, according to the mapping 165, the memory access request to the memory device 141 to access its portion 151.

In general, different ways to map the portions (e.g., 152, 158) in the space 171 to the memory devices (e.g., 141, 145) can lead to different performance levels (e.g., average latency in access in the random access memory 112 during a period of time).

The reinforcement learning module 291 can be configured to periodically adjust the mapping 165 to maximize the performance of the random access memory 112 implemented using the portions (e.g., 151, 157) of the memory devices (e.g., 141, 145).

For example, instead of implementing the portion 152 of the space 171 using the portion 151 allocated from the memory device 141, the fabric 121 can replicate the data in the portion 151 of the memory device 141 to a portion 159 allocated from the memory device 143 and then map the portion 152 of the space 171 to the portion 159 allocated from the memory device 143 (and free the portion 151 previously allocated to implement the portion 152 of the space 171).

For example, instead of implementing the portion 152 of the space 171 using a portion (e.g., 151) allocated from the memory device 141 and implementing the portion 156 of the space 171 using a portion (e.g., 155) allocated from the memory device 143, the mapping 165 can be change to implement the portion 152 of the space 171 using a portion (e.g., 155) allocated from the memory device 143 and implementing the portion 156 of the space 171 using a portion (e.g., 151) allocated from the memory device 141.

The reinforcement learning module 291 can be configured to measure the rewards realized from implementing different options of selections and update a reward table (e.g., according to Q-learning) to learn to select best options for maximizing rewards. The actual rewards realized as a result of adjustments can be determined based on a performance indicator (e.g., average latency) of the random access memory 112 in a recent period of operations of the computing system 100. Thus, the optimization learnt by the reinforcement learning module 291 can adapt intelligently to the recent patterns of memory access in the operations of the computing system 100.

Optionally, the adjustments of the mapping 165 can include the options to use a compression technique selected from a plurality of predetermined compression techniques.

For example, the data 162 stored in a portion 151 of the memory device 141 used to implement the portion 152 of the mapped memory space 171 can become cold. Thus, the benefit of using the portion 151 to hold the data 162 can reduce; and there can be benefits in freeing at least partially the portion 151 of the memory device 141 to implement another portion (e.g., 154) of the space 171 that is used more frequently in a recent time period.

Thus, the mapping 165 can be adjusted by moving the data 162 from the portion 151 in an uncompressed form to a portion 159 in another memory device 143 as compressed data 164. After the data move, the mapping 165 can be further adjusted by move the data from the portion 155 to the portion 151; or use the portion 151 to implement another portion of the memory space 171 that is not yet implemented using the memory cells in the memory devices 141, 143, . . . , 145. Further, such adjustments can include the options to select a compression technique, from a plurality of compression techniques, to generate the compressed data 164 from the uncompressed data 162. The reinforcement learning module 291 can measure the rewards (e.g., based at least in part on the average latency of the random access memory 112 in a period of the predetermined time interval) for implementing such an option of adjusting the mapping 165. In general, there can be multiple options; and through reinforcement learning, the module 291 can learn the best options to select for a period of the predetermined interval in view of a current state of operation.

Optionally, the reinforcement learning module 291 can include a compression model 166 configured to select a compression technique from a plurality of compression techniques in generation of the compressed data 164.

In some instances, it can be advantageous to predictively/preemptively decompress the compressed data (e.g., 164) in adjusting the mapping 165. The reinforcement learning module 291 can include a decompression model 168 configured to learn the rewards for using different options to select compressed data (e.g., 164) for decompression and for placement of the decompressed data (e.g., 162).

Options for selecting data for compression or decompression can be formulated based at least in part on age (e.g., time since memory allocation to hold the uncompressed data or compressed data), access frequency (e.g., rate of accessing the data), last access (e.g., lapsed time since last accessing the data), dominant access type (e.g., whether the access to the portion of the mapped memory space 171 is primarily read or write), context information (e.g., provided via metadata included in memory access requests and/or responses), etc.

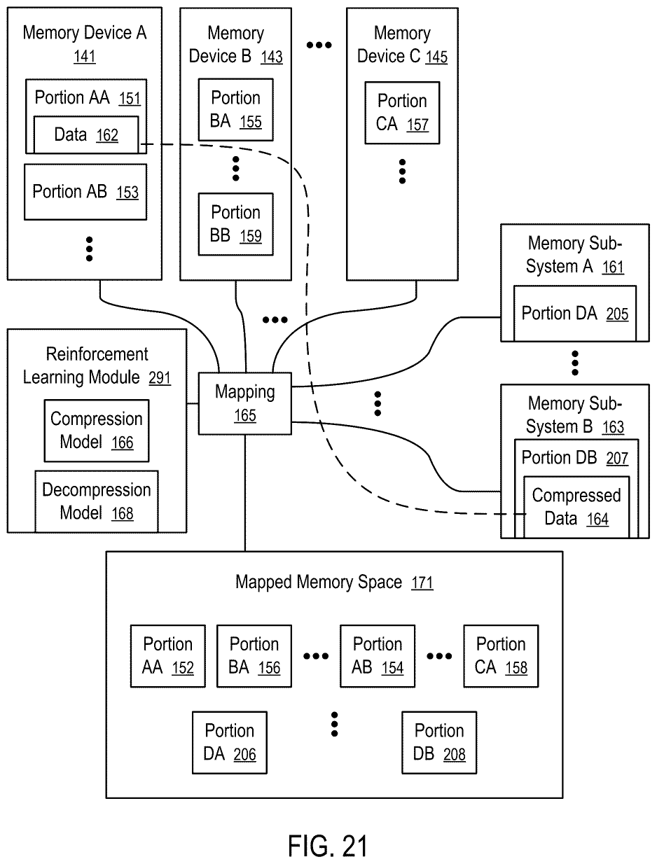

In some implementations, the reinforcement learning module 291 is configured to adjust the mapping from the space 171 not only to portions in the memory devices 141, 143, . . . , 145, but also to portions in the storage spaces (e.g., 201, 203) of memory sub-systems (e.g., 161, 163), as in FIG. 21.

FIG. 21 shows a reinforcement learning module configured to optimize mapping from a mapped memory space to random access memories in memory devices and to storage spaces in memory sub-systems connected to a computer express link fabric according to one embodiment.

As in FIG. 20, the portions 152, 156, . . . , 154, . . . , 156 of the mapped memory space 171 are implemented using the respective portions 151, 155, . . . , 153, . . . , 157 in the memory devices 141, 143, . . . , 145. Further, portions 206, . . . , 208 are mapped to corresponding portions 205, . . . , 207 of the storage spaces of the memory sub-systems 161, . . . , 163. Thus, the data in the portions 206, . . . , 208 in the space 171 has persistent storage in the memory sub-systems 161, . . . , and 163; and the mapped memory space 171 can be significantly larger than the combined capacity of the memory devices 141, 143, . . . , and 145.

In general, the computing system 100 can have different patterns of accessing different portions of the mapped memory space 171; and the reinforcement learning module 291 can adjust the mapping 165 to optimize the latency of the random access memory represented by the space 171.

For example, when the portion 206 is accessed, the fabric 121 can use a submission queue 181 to send command to retrieve data from the portion 205 of the memory sub-system 161 into a portion 159 allocated from the memory device 143 and map the portion 206 of the space 171 to the portion 159 in the memory device 143.

The reinforcement learning module 291 can be configured to adjust the mapping 165 periodically to seek an optimal or near optimal mapping 165 that can result in an improved performance (e.g., average latency over a recent period of time). For example, the optimization can be based on a reward table updated according to Q-learning to learn to select best options for placing the data of the portions (e.g., 152, 206) of the space 171 into portions (e.g., 151, 205) allocated from the memory devices 141, 143, . . . , 145 and the memory sub-systems 161, . . . , 163. For example, the rewards can be measured based on a performance indicator (e.g., average latency) of accessing the space 171 in a recent period of operations of the computing system 100. Thus, the optimization learnt by the reinforcement learning module 291 can adapt intelligently to the recent patterns of memory access in the operations of the computing system 100.

The reinforcement learning module 291 can include a compression model 166 configured to select options to apply selected compress formats to selected data in moving data from one placement location (e.g., in a portion 151 in a memory device 141) to another (e.g., in a portion 207 in a memory sub-system 163, or in a portion 159 in another memory device 143 as in FIG. 20). For example, the compression model 166 can have a set of expected reward values trained or learned using a reinforcement learning technique (e.g., Q-learning) over a number of iterations of adjusting the mapping 165.

For example, the rewards for the selection of a compression option can be based on effects of the compression options on maximizing a combined goal to provide an increased average number of free memory cells over a time period of the predetermined interval.

For example, to measure the effect of compression on the data 162 using a compression technique, the computer express link fabric 121 and/or the controller 122 can determine or estimate the actual compression ratio of applying the compression technique to the data 162 thus the amount of memory saving that can be achieved via the use of the compression technique. Further, the computer express link fabric 121 and/or the controller 122 can determine the amount of time the memory saving is available as a result of a need to decompress the data 162 for a next access, the time used to apply the compression, and/or the time to relocate the data. In general, such a reward can be dependent on a state of operation (e.g., age, access frequency, last access, dominant access type, context information, etc. of data 162). Thus, the compression model 166 can be trained/updated via a reinforcement learning technique to obtain expected reward values for various states to facilitate a best selection option for a current state.

In some implementations, the effect of compression on the data 162 using a compression technique are measured without actually performing the compression to reduce the cost associated with the training of the compression model 166. For example, a compression ratio can be estimated based on a type of the data 162 and/or an identification of the compression technique. Alternatively, a sample of the data 162 is compressed using the compression technique to obtain an estimate of the compression ratio for applying the compression technique to the data 162 in entirety.

Similarly, the length of time to perform the compression on the data 162 can be estimated (e.g., based on an attribute of the data 162, the identification of the compression technique, and/or compression a random sample of the data 162).

In some implementations, when the utilization rate of the memory devices 141, 143, . . . , 145 (e.g., a ratio between the random access memory cells in use and the total random access memory cells in the memory devices 141, 143, . . . , 145) is below a threshold, the controller 122 can train the compression model 166 without actually performing the compression operations to learn the best options based on compression ratio estimates, compression time estimates, and actual time patterns for accessing the data (e.g., 162).

In some implementations, the computer express link fabric 121 and/or the controller 122 can postpone applications of compression until there is an insufficient amount of free random access memory cells in the memory devices 141, 143, . . . , 145 to implement a portion of the mapped memory space 171. In response to a decision to select a portion of the random access memory cells in the memory devices 141, 143, . . . , 145, the computer express link fabric 121 and/or the controller 122 can use the compression model 166 to identify a best option of compressing a selected portion (e.g., 151) using a selected compression technique that can provide the maximized rewards according to the compression model 166. For the training of the compression model 166, the computer express link fabric 121 and/or the controller 122 can use estimates to avoid compressing candidates, or compressing candidates in entirety (e.g., compressing only a random sample from each candidate (e.g., data 162)) to obtain an estimate.

Optionally, or in combination, the values of expected rewards can be further based on an impact of applying the compression technique to selected data (e.g., 162) on an average latency of the random access memory 112 in a time period of the predetermined interval.

Optionally, or in combination, the values of expected rewards can be further based on the offloading of the compressed data 164 to another location (e.g., in another memory device 143, or in a memory sub-system 163).

Optionally, or in combination, the values of expected rewards can be further based on the reusing of the portion 151 of the memory device 141 holding the uncompressed data 162.

The reinforcement learning module 291 can include a decompression model 168 configured to select compressed data (e.g., 164) for preemptive decompression.

When the compressed data 164 is decompressed predictively/preemptively and placed in a memory device (e.g., 141), the latency of responding to a subsequent request to access the data can be reduced. To train the decompression model 168, the controller 122 can measure the rewards for applying preemptive decompression to a candidate (e.g., compressed data 164) at a given state (e.g., age, access frequency, last access, dominant access type, context information, etc. of data 164).

For example, the rewards for preemptive decompression can be based on reduction of latencies in one or more subsequent memory access requests to access the data 164. The biggest reduction is for the first memory access request after the decompression; the reduction can reduce for subsequent memory access requests; and after a time period that follows the first memory access request and that has a length equal to the time required to perform the decompression, the benefit of preemptive decompression to further memory access request diminishes. On the other hand, it can be desirable to delay the preemptive decompression to reduce the demand for free random access memory cells in the memory devices 141, 143, . . . , 145. Thus, the benefits in the latency reductions can be discounted by the time period between the initiation of the decompression and the first memory access request. As the time period increases, the latency reduction benefits can be discounted more. Different memory access patterns corresponding to different states can lead to different expected reward values for applying preemptive decompression to the compressed data 164. The controller 122 can train the decompression model 168 to allow the identification of a best timing to apply preemptive decompression to a candidate (e.g., compressed data 164) that can provide the most rewards.

In some instances, when the amount of free random access memory cells in the memory devices 141, 143, . . . , 145 is low, the controller 122 is configured to balance the tradeoff between the cost of offloading and/or compressing a portion and the benefit of preemptively decompressing a candidate (e.g., data 162) that can offer the most rewards.

In some implementations, the decompression model 168 is trained for options that involving compressing a portion and preemptively decompressing another portion to maximize reduction of latency in accessing both portions.

In some implementations, to measure the latency reduction for preemptive decompression of a candidate (e.g., data 164), the length of the time duration to perform the decompression is estimated to avoid performing the operation of decompression operations. The timing of the actual memory access requests can be used to determine the rewards for latency reduction and to discount the reward for an excessive time gap between the decompression and the memory access that can have the biggest latency reduction.

Optionally, or in combination, the values of expected rewards for preemptive decompression can be further based on an impact of applying the decompression the average latency of the random access memory 112 in a time period of the predetermined interval. The impact can be a result from the need to offload and/or compress data to free some of the random access memory cells to hold the decompressed data. In some implementations, decompression of a data candidate is paired with compression of another data candidate as one option.

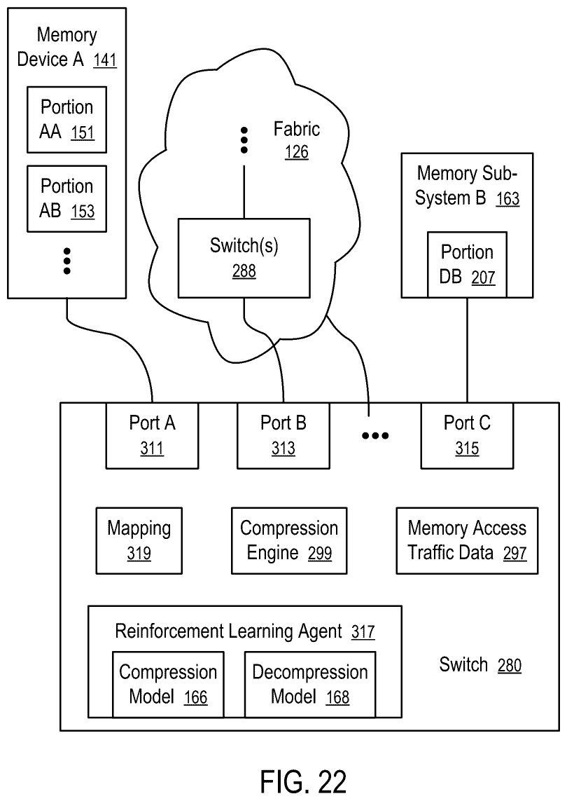

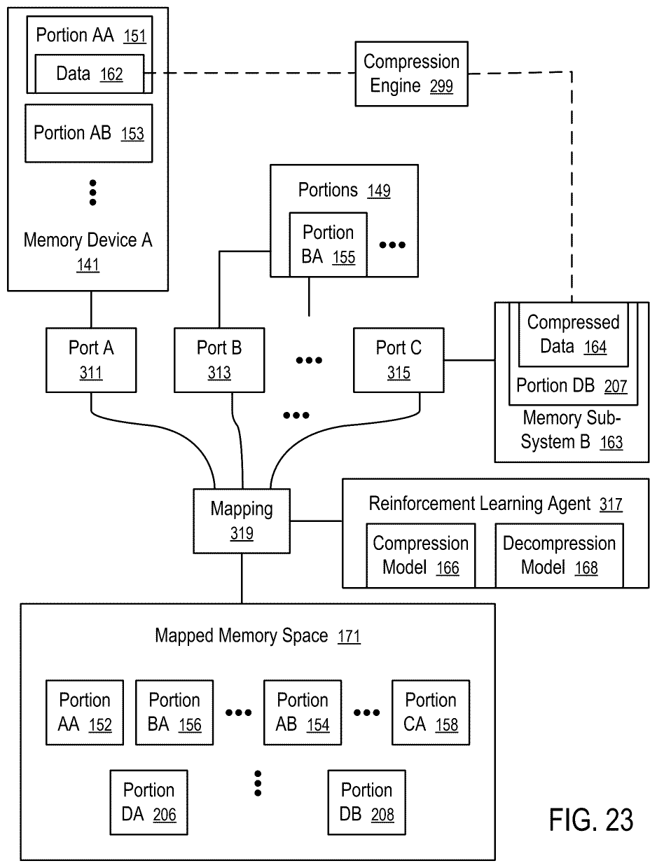

As discussed above in connection with FIG. 18 and FIG. 19, the reinforcement learning module 291 can be implemented using a set of reinforcement learning agents 317 running in their respective computer express link switches (e.g., 281, 283, . . . , 285). For example, the reinforcement learning module 291 of FIG. 20 and FIG. 21 can be implemented using reinforcement learning agents (e.g., 317) configured as in FIG. 22 and FIG. 23.

FIG. 22 and FIG. 23 show a reinforcement learning agent configured in a computer express link switch to optimize routing of memory access requests and memory mapping according to one embodiment.

As an example, FIG. 22 illustrates a switch 280 having a port 311 connected to a memory device 141, a port 315 connected to a memory sub-system 163, and one or more ports 313 connected to other computer express link switches 288. In general, a switch (e.g., 280) can have no memory device connected directly to any of its ports and/or no memory sub-system connected directly to its ports. Optionally, a switch (e.g., 280) can have a host device (e.g., 118, 128, or 129) connected directly to one of its ports 311, 313, . . . , and 315.

Having a memory device 141 and a memory sub-system 163 connected directly to some ports (e.g., 311 and 315) of the switch 280 allows the mapping 319 configured in the switch 280 to specify which portions (e.g., 152, 154, 206) of the mapped memory space 171 (e.g., in FIG. 21 and/or FIG. 23) are mapped via which ports of the switch 280 to portions (e.g., 151, 154, 205) in the memory device 141 and/or the memory sub-system 163.

The switches 288 connected to the switch-connected ports (e.g., 313) of the switch 280 can be viewed, by the switch 280, as a fabric 126 that offers additional memory and storage resources (e.g., portions 149 of memory devices 143, . . . , 145 and a memory sub-system 161) to implement other portions (e.g., 156, 158, 208) of the space 171.

The switch 280 can structure its mapping 319 based on the ports (e.g., 311, 313, . . . , 315) of the switch 280, as illustrated in FIG. 23.

For example, some portions (e.g., 152, 154) of the mapped memory space 171 are mapped for routing via a port (e.g., 311) of the switch 280 to a memory device (e.g., 141); some portions (e.g., 208) of the space 171 are mapped for accessing via another port (e.g., 315) of the switch 280 to a memory sub-system 163; and other portions (e.g., 156) of the space 171 are mapped for routing via one or more of the switch-connected ports (e.g., 313) over a fabric 126 as seen by the switch 280. The fabric 126 is typically a portion of the computer express link fabric 121 in which the switch 280 is configured.

For example, when an incoming memory access request reaches a port of the switch 280, the switch 280 can check whether the memory address identified in the memory access request is mapped to any memory device (e.g., 141) connected directly to a device-connected port (e.g., 311) of the switch 280. If so, the switch 280 routes the memory access request to the port (e.g., 311) to access a respective address in the memory device (e.g., 141) according to the mapping 319.

For example, when an incoming memory access request reaches a port of the switch 280, the switch 280 can check whether the memory address identified in the memory access request is mapped to any memory sub-system (e.g., 163) connected directly to a port (e.g., 315) of the switch 280. If so, the switch 280 can allocate a portion of the random access memory from a memory device (e.g., 141) connected to a device-connected port (e.g., 311) of the switch, or from the fabric 126, and remap a portion (e.g., 208) of the mapped memory space 171 from the portion (e.g., 207) of the memory sub-system (e.g., 163) to the allocated portion of the random access memory.

For example, the switch 280 can enter a read command into a submission queue (e.g., 185) configured for the memory sub-system 163 (e.g., as in FIG. 9) to retrieve the content of the portion (e.g., 207) of the memory sub-system 163 into the allocated portion of the random access memory. After the completion of the remapping, the switch 280 can route the incoming memory access request having a memory address in the portion 207 to the memory device (e.g., 141) or the fabric 126 from which the portion of the random access memory is allocated.

When the mapping 319 indicates that the memory address in an incoming memory access request is to be routed via the fabric 126 connected to one or more switch-connected ports (e.g., 313) of the switch 280, the switch 280 can have the options to route the request through more than one of the ports (e.g., 313) of the switch 280. The reinforcement learning agent 317 can use a Q-learning technique to learn the estimated rewards for using any of the ports, based on the states of the switch 280, and subsequently select a routing option that maximizes rewards.

For example, the memory access traffic data 297 stored in the switch 280 can be used to identify a current state of the switch 280, among a plurality of states. The current state of the switch 280 can be based on the current operating statuses of the ports 311, 313, . . . , and 315, pending requests to be routed through the ports, expected responses to be received via the ports, etc.

For each of the switch-connected ports (e.g., 313) and for the current state of the switch 280, the reinforcement learning agent 317 can maintain an expected reward value that indicates an amount of reward the switch 280 is expected to receive for routing the incoming memory access request through the respective switch-connected port (e.g., 313). The reinforcement learning agent 317 can select one of the switch-connected ports (e.g., 313) that has the largest reward value for the current state of the switch 280 to seek maximum rewards, or randomly select one of the switch-connected ports (e.g., 313) during exploration of possible reward. After routing the incoming memory access request to the selected port (e.g., 313), the switch 280 can evaluate/measure the effect/reward resulting from the routing of the request to the selected port (e.g., 313). For example, after the request is processed, the switch 280 can determine the latency of a response to the request. The measured reward for the routing decision can be a function of the latency such that the smaller the latency the larger is the reward. Routing the request to the selected port can cause the switch 280 to enter a next state (which can be different from the current state in making the routing decision); and the reinforcement learning agent 317 can evaluate the largest expected reward value for the next state. The reinforcement learning agent 317 can update the expected reward value for the selected port for the current state using the measured reward and the largest expected reward value for the next state.

For example, the largest expected reward value for the next state can be multiplied by a predetermined discount factor for summation with the measured reward. The expected reward value for the selected port and the current state can be updated to a weight average of its current value and the sum of the measured reward and the discounted largest expected reward value for the next state.

After a number of iterations and/or explorations, the reward values maintained by the reinforcement learning agent 317 can converge and use to select switch-connected ports for routing incoming memory access requests. The updated/converged reward values can cause the switch 280 to select optimal or near-optimal routing decisions.

Periodically, the switch 280 can adjust its mapping 319 to explore optimized placements of data in the memory devices (e.g., 141), in the memory sub-systems (e.g., 163), and/or in the fabric 126 connected to the switch-connected ports (e.g., 313) of the switch 280.

For example, the switch 280 can map the portion 156 that is previously in the portion 155 in the fabric 126 to the memory device 141 to reduce the latency in accessing the portion 156 of the space 171.

For example, the switch 280 can map the portion 208 that is previously in the portion 207 of the memory sub-system 163 to the memory device 141 to reduce the latency in accessing the portion 208 of the space 171.

For example, the switch 280 can map the portion 154 that is previously in the portion 153 of the memory device 141 to the fabric 126, or to the memory sub-system 163, to free up resources in the memory device 141 for implementing another portion (e.g., 206) of the mapped memory space 171.

The reinforcement learning agent 317 can establish a reward table for the placement of data for portions (e.g., 152, 208) of the space 171 in resources connected to the ports 311, 313, . . . , 315 of the switch 280, such as the memory device 141, the fabric 126, and the memory sub-system 163. The reward table can be configured for a plurality of placement options. When a placement option is selected, the switch 280 can measure/evaluate the effect/reward of using the option. For example, the measured reward for the placement option can be a function of an average latency of memory access requests routed through the switch 280 during a time interval such that the smaller the average latency the larger is the reward. After a number of iterations and/or explorations, the reward values maintained by the reinforcement learning agent 317 for the placement options can converge and use to select placement options that can result in optimal or near-optimal results in reducing the average latency of memory access requests routed through the switch 280.

For example, the reinforcement learning agent 317 can identify a plurality of states of the switch 280 relevant to data placements. For example, a current state of the switch 280 for data placement can be based on the statistics of the memory access traffic data 297 over the recent time interval. Q-learning can be used to learn the reward values for selecting a placement option for a current state, among the plurality of possible states.

The switch 280 can have a compression engine 299 operable to compress data using any of a plurality of compression techniques (e.g., LZ77, LZ4, Lempel-Ziv-Markov chain algorithm (LZMA), deflate implemented in zlib).

The switch 280 can use the compression engine 299 to compress data (e.g., 162) retrieved from a memory device (e.g., 141) connected via a computer express link connection directly to a device-connected port (e.g., 311) of switch 280 using a compression technique identified using a compression model 166 of the reinforcement learning agent 317. The compressed data (e.g., 164) can be transported, via the fabric 126 or another port, to another memory device (e.g., 143 or 145) or a memory sub-system (e.g., 161 or 163), for storing in a compressed format.

The compression model 166 of the reinforcement learning agent 317 can be trained, using a reinforcement learning technique (e.g., Q-learning) to maximize rewards for the selection of the data for compression and for the selection of the compression technique for the data, in a way similar to that discussed above in connection with FIG. 20 and FIG. 21.

When the compressed data (e.g., 164) is to be decompressed in response to a memory access request or a preemptive decompression decision, the switch 280 can retrieve the compressed data (e.g., 164) and use the compression engine 299 to decompress the data as uncompressed data (e.g., 162) in a memory device (e.g., 141) connected to a device-connected port (e.g., 311) of the switch 280. The mapping 319 can be updated to route the memory address requests in the portion (e.g., 152) of the mapped memory space 171 to the portion (e.g., 151) in the memory device (e.g., 141) allocated to hold the uncompressed data (e.g., 162).

A decompression model 168 of the reinforcement learning agent 317 can be trained, using a reinforcement learning technique (e.g., Q-learning) to maximize rewards for the selection of the data for preemptive compression, in a way similar to that discussed above in connection with FIG. 20 and FIG. 21.

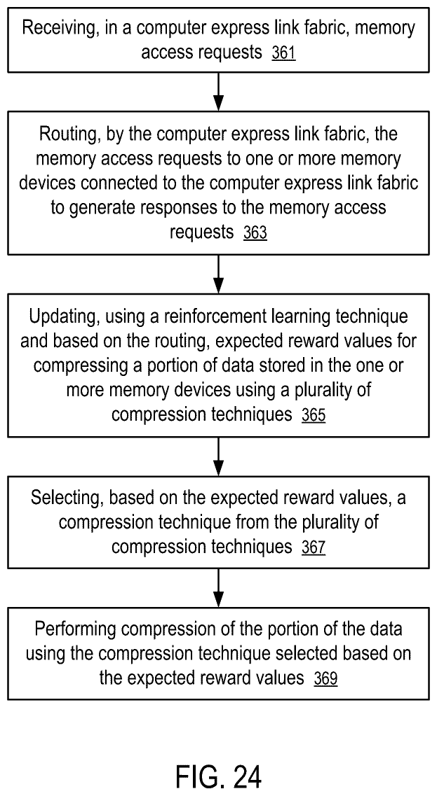

FIG. 24 shows a method to manage compression of data accessible via a computer express link fabric according to one embodiment. For example, the method of FIG. 24 can be implemented in a controller 122 and/or a computer express link switch 280 of a computer express link fabric 121 discussed above in connection with FIG. 1 to FIG. 23.

At block 361, the method of FIG. 24 includes receiving, in a computer express link fabric 121, memory access requests (e.g., 211).

At block 363, the method includes routing, by the computer express link fabric 121, the memory access requests (e.g., 211) to one or more memory devices (e.g., 123; 141, 143, . . . , 145) connected to the computer express link fabric 121 to generate responses to the memory access requests (e.g., 211).

At block 365, the method includes updating, using a reinforcement learning technique and based on the routing at block 363, expected reward values (e.g., a reward table in a compression model 166) for compressing a portion of data (e.g., 162) stored in the one or more memory devices using a plurality of compression techniques (e.g., LZ77, LZ4, Lempel-Ziv-Markov chain algorithm (LZMA), deflate implemented in zlib).

At block 367, the method includes selecting, based on the expected reward values (e.g., a reward table in the compression model 166), a compression technique from the plurality of compression techniques.

For example, the method of FIG. 24 can further include updating, using the reinforcement learning technique and based on the routing at block 363, a plurality of sets of expected reward values for compressing respectively a plurality of portions of the data stored in the one or more memory devices (e.g., 123; 141, 143, . . . , 145). Each of the plurality of sets is for one of the plurality of portions. The computer express link fabric 121 can select, based on the plurality of sets of expected reward values, the portion of the data (e.g., data 162) for compressing using the selected compression technique.

In some implementations, the selecting at block 367 is in response to a need to allocate free random access memory cells from the memory devices (e.g., 141, 143, . . . , 145) to implement a portion of the mapped memory space 171 that is being accessed by an incoming memory access request (e.g., 211), or in response to a utilization rate of random access memory cells in the memory devices (e.g., 141, 143, . . . , 145) is above a threshold. In such a situation, a reinforcement learning module 291 in a controller 122 of the fabric 121 and/or a reinforcement learning agent 317 in a switch (e.g., 280; 281, 283, . . . , or 285) in the fabric 121 can select a portion of data (e.g., 162) using a compression model 166 updated at block 365.

For example, the expected reward values in the compression model 166 can include a plurality of subsets configured respectively for a plurality of states of operation. The reinforcement learning module 291 and/or the reinforcement learning agent 317 can determine a current state of operation and used a subset that corresponds to the current state of operation for the selecting at block 367.

For example, at the current state of operation, a plurality of maximum expected reward values can be determined for the plurality of portions respectively. Each of the plurality of maximum expected reward values is determined from maximizing rewards for compressing one of the plurality of portions. For compression each of the plurality of portions, different compression techniques can lead to different compression rewards; and a maximum expected reward value can be determined for compressing one of the portions, which corresponding to the determination of the most rewarding compression technique for compressing the corresponding portion. A largest one of the plurality of maximum expected reward values can be selected to identify the portion that can lead to the maximum rewards, among the plurality of portions, and the most rewarding compression technique for the identified portion.

For example, for each portion that is candidate for compression, the current state of operation can be based on: an age of allocation of the random access memory cells to store the portion; an access frequency of the portion; a lapsed time since last accessing the portion; a dominant type of accessing the portion; or an application context of the portion; or any combination thereof.

For example, to update a respective expected reward value for compressing a portion of data (e.g., data 162) at block 365, the reinforcement learning module 291 and/or the reinforcement learning agent 317 can measure an amount of rewards for performing compression of the portion of the data at a state of operation using a first compression technique among the plurality of compression techniques. The amount of rewards can be a function of: an amount of random access memory cells that can be freed after applying the first compression technique to the portion of the data (e.g., data 162); and a time gap between completion of applying, responsive to the state of operation, the first compression technique to the portion of the data (e.g., data 162) and a subsequent request to access the portion of the data (e.g., data 162).

For example, the amount of rewards can be measured for the updating at block 365 without actually performing compression operations on the portion of the data (e.g., data 162).

For example, for example, the amount of reduction and the time length of the compression operation can be estimated based on a classification of the portion of the data (e.g., data 162) and the identification of the compression technique. Alternatively, a random sample can be compressed to obtain the estimate without retrieving and compressing the data 162 in its entirety.

Alternatively, the amount of reduction and the time gap can be measured based on performing compression operations on the data 162. For example, the controller 122 or the switch (e.g., 280 that is closest to the data 162 in the fabric 121) can retrieve the data 162 from the memory device 141 over one of its device-connected ports (e.g., 311) at the current state of operation, apply a compression technique to the data 162 to generate the compressed data 164, and determine the actual amount of random access memory cells that can be freed after the compression (e.g., by storing the compressed data 164 back to the memory device 141). Further, the controller 122 or the switch (e.g., 280 that is closest to the data 162 in the fabric 121) can determine the actual time gap between a first time instance of the completion of the compression of the data 162 and a second time instance when the data 162 needs to be decompressed (e.g., in view of an incoming memory access request that addresses the data 162). The benefit and the reward of the compression is proportional to the amount of reduction and the time gap. For example, the reward can be a function the amount of reduction multiplied by the length of the time gap.

When the amount of reduction and the time gap are estimated without actually performing the compression, the reward values for applying different compression techniques can be determined concurrently for the plurality of compression techniques to speed up the learning of the compression model 166.

At block 369, the method includes performing compression of the portion of the data (e.g., data 162) using the compression technique selected based on the expected reward values.

In some implementations, the expected reward values for the portion of data (e.g., data 162 as a compression candidate) are learnt and updated in a compression model 166 in a switch 280 that is closest to the portion of data (e.g., 162) in the fabric 121. The switch 280 allocates a portion 151 of random access memory cells from a memory device 141 that is connected, via a computer express link fabric connection, directly (e.g., without an intervening switch) to a device-connected portion 311 of the switch 280. The allocated portion is used by the switch 280 to implement a portion (e.g., 152) of the mapped memory space 171 and thus store the data 162. The switch 280 can optionally implement the portion (e.g., 152) of the mapped memory space 171 in a compressed format to reduce the usages of the random access memory cells in the memory device 141.

Alternatively, or in combination, the expected reward value for applying a compression technique to the data 162 can be learnt based on an average latency of responses to memory access requests routed through the computer express link switch 280 during a time period of a predetermined interval following a first operation selected to compress the data 162 using a compression technique among the plurality of compression techniques. Optionally, the first operation is further configured to offload a compressed version of the portion of the data to outside of the memory device 141 and to allocate the random access memory cells for memory addresses different from memory addresses of the data 162. For example, compression of the data 162 can be paired with using at least a portion of the memory device 141 free from the compression to implement another portion of the mapped memory space 171; and the rewards can be maximized via reinforcement learning (e.g., Q-learning) to improve the average latency.

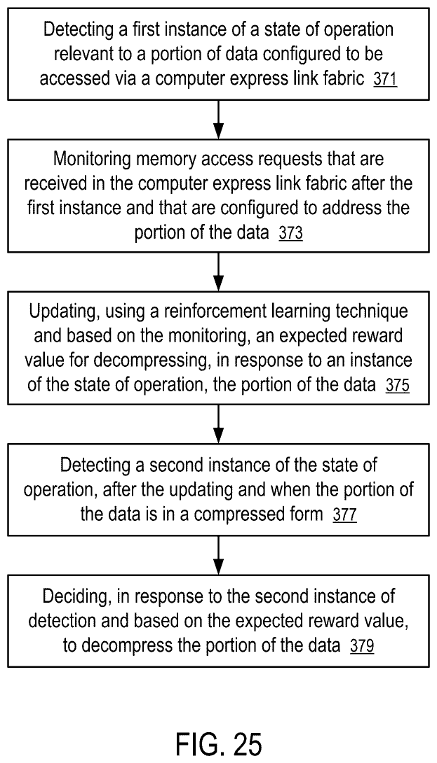

FIG. 25 shows a method of preemptive decompression of data for access via a computer express link fabric according to one embodiment. For example, the method of FIG. 25 can be implemented in a controller 122 and/or a computer express link switch 280 of a computer express link fabric 121 discussed above in connection with FIG. 1 to FIG. 23. The method of FIG. 25 can be used in combination with the method of FIG. 24.

At block 371, the method of FIG. 25 includes detecting a first instance of a state of operation relevant to a portion of data configured to be accessed via a computer express link fabric 121.

For example, the portion of the data can be data 162 in an uncompressed form, or data 164 in a compressed form, in a portion (e.g., 152) of a mapped memory space 171. When a memory access request (e.g., 211) received in the fabric 121 has a memory address (e.g., 213) in the portion (e.g., 152) of the mapped memory space 171, the memory address request (e.g., 211) is to be routed via the fabric 121 to access the portion of the data (e.g., 162) in an uncompressed form. The fabric 121 can host the portion of the data (e.g., 162) at different physical locations (e.g., different sets of random access memory cells allocated from the memory devices 141, 143, . . . , 145) at different times. The mapping 165 and/or 319 identifies the current placement of the portion of the data and its format (e.g., uncompressed, compressed, compression technique used).

For example, the state of operation can be based at least in part on: an age of allocation of random access memory cells (e.g., allocated from memory devices 123, 141, 143, . . . , 145 connected to the fabric 121) to store the portion of the data; an access frequency of the portion of the data; a lapsed time since last accessing the portion of the data; a dominant type of accessing the portion of the data; or an application context of the portion of the data; or any combination thereof.

At block 373, the method includes monitoring memory access requests (e.g., 211) that are received in the computer express link fabric 121 after the first instance and that are configured to address the portion of the data.

For example, the monitoring at block 373 can include: determining a time length between the first instance of the state of operation and receiving of a memory access request in the computer express link fabric addressing the portion of the data; and determining timing of one or more memory access requests received in the computer express link and received within a time window starting from the receiving of the memory access request and sufficient to perform and complete decompression of the compressed version the portion of the data.

For example, when the portion of the data is in a compressed form and the predictive decompression is performed in response to reaching the state of operation, the predictive decompression can have the benefit of reducing the latency of responding to one or more memory access requests addressing the portion of the data after the state of operation is reached. When the time length is equal to the time required to perform the operation of decompression, the reduction in the latency of responding to the memory access request reaches a maximum. However, when the time length is longer than the time required to perform the operation of decompression, it is possible to delay the decompression without reducing the benefit. Delaying the decompression can reduce the time for the uncompressed data to wait for an access request, and potentially increases the utilization of random access memory cells allocated to hold the uncompressed data.

If decompression is delayed until the receipt of the memory access request that addresses the portion of the data, the memory access request can trigger the decompression; and the latency of responding to further memory access requests received after the completion decompression triggered by the memory access request are not impacted by the delay caused by the decompression. Thus, predictive decompression offers no benefits for such memory access requests received after the time window starting from the receiving of the memory access request and sufficient to perform and complete decompression of the compressed version the portion of the data. However, decompression performed before the receipt of the memory access request that would trigger the decompression can reduce the latency of responding to memory access requests received during the time window. Thus, the reinforcement learning module 291 and/or the reinforcement learning agent 317 can be configured to monitor the timing of such memory access requests received during the time window to measure the total reduction in latency and thus the benefit of the predictive decompression responsive to reaching the state of operation.

In some implementations, the compressed data is stored in place in a memory device (e.g., 141) where the uncompressed data is to be stored for access.

Thus, the time to complete compression can include the time for a switch (e.g., 280) connected to the memory device (e.g., 141) to retrieve the data, perform decompression, and write uncompressed data back to the memory device (e.g., 141).

In some implementations, the compressed data (e.g., 164) is stored in a memory sub-system (e.g., 163) that is separate from a memory device (e.g., 141) where the uncompressed data (e.g., 162) is to be stored for access. Thus, the time to complete compression can include the time for a switch (e.g., 280) to use a submission queue (e.g., 185) to retrieve the compressed data (e.g., 164), perform decompression, and write uncompressed data to the memory device (e.g., 141).

At block 375, the method includes updating, using a reinforcement learning technique (e.g., Q-learning) and based on the monitoring at block 373, an expected reward value (e.g., in a decompression model 168) for decompressing, in response to an instance of the state of operation, the portion of the data.

For example, the updating at the block 375 can be based at least in part on the time length between the first instance of the state of operation and receiving of the memory access request in the computer express link fabric 121 addressing the portion of the data, as monitored at block 373. The updating at the block 375 can be further based on the timing of one or more memory access requests received in received within the time window starting from the receiving of the memory access request and sufficient to perform and complete decompression of the compressed version the portion of the data.

For example, the reinforcement learning module 291 and/or the reinforcement learning agent 317 can determine a total reduction of latency in responding to the one or more memory access requests. The reinforcement learning module 291 and/or the reinforcement learning agent 317 can compute a reward for decompressing the portion of the data in response to the first instance of the state as a function of the time length and the reduction of latency.

For example, the function can be configured to reduce the reward for increasing in the time length and to increase the reward for increasing the reduction of latency. The reward as computed from the function and based on the memory access pattern following the first instance of the state of operation can be used to update an expected reward value in the decompression model 168 using a Q-learning technique (e.g., as a weighted average of a previous version of the expected reward value and the computed reward, weighted according to a learning rate).

In some implementations, the reward is computed without performing decompression of the portion of the data. For example, the time to be used to decompress the data 164 can be estimated and stored as metadata of the compressed data 164. For example, during the compression of the data 162, the time needed for decompression can be estimated and stored. Alternatively, the decompression is performed once to record the time to be used for the decompression operation.

Further, the training of the decompression model 168 (e.g., updating the expected reward value for the state of operation and for other states of operations) can be performed based on the memory access patterns in the fabric 121 and/or a switch (e.g., 280) without the data 162 being compressed. For example, the reinforcement learning module 291 and/or the reinforcement learning agent 317 can use a time period of normal operations of memory access to the portion 151 in the memory device 141 to train the compression model 166 and the decompression model 168 before deciding to compress the data 162 and subsequently decompress it. Thus, the compression model 166 and the decompression model 168 can evolve and adapt to the recent memory access patterns in accessing the corresponding portion (e.g., 152) of the mapped memory space 171.

At block 377, the method includes detecting a second instance of the state of operation, after the updating and when the portion of the data is in a compressed form.

At block 379, the method includes deciding, in response to the second instance of detection and based on the expected reward value, to decompress the portion of the data. The deciding can be in response to the second instance of the state of operation without receiving a memory access request configured to address the portion of the data and/or without a memory access request pending to be routed through the fabric and/or to be routed by a switch (e.g., 280) to one of a plurality of ports (e.g., 311, 313, . . . , 315) of the switch (e.g., 280) to access the portion of the data.

For example, the deciding at block 379 can be based at least in part on the expected reward value being above a threshold.

In some implementations, a different portion of the data is to be compressed to free some random access memory cells to hold the uncompressed data (e.g., 162). The threshold can be based on an estimate of cost of compressing the different portion of the data. For example, the cost can be estimated based on the benefit/reward of compressing the different portion (e.g., as determined using the compression model 166).

In same implementations, the reinforcement learning module 291 and/or the reinforcement learning agent 317 can iteratively determine an estimated reward value for taking a combined action of decompressing the portion of the data and compressing the different portion of the data. The reward for taking such a combined action at an instance of a particular state of operation can be measured based on an average latency of responding to memory access requests received in the time period of a predetermined interval following the instance of the particular state. The combined action can include the options to offload the compressed data to another memory device (e.g., 143, or 145), or to a memory sub-system (e.g., 161 or 163).

A non-transitory computer storage medium can be used to store instructions programmed to implement a fabric manager 413 containing a reinforcement learning module 291 and/or a reinforcement learning agent 317. When the instructions are executed by the processing device 118, the controller 115, the processing device 117, the controller 122, and/or the computer express link switches (e.g., 280; 281, 283, . . . , 285), the instructions cause the computer express link fabric 121, its controller 115 and/or the computer express link switches (e.g., 280; 281, 283, . . . , 285) in the fabric 121 to perform the methods discussed above.

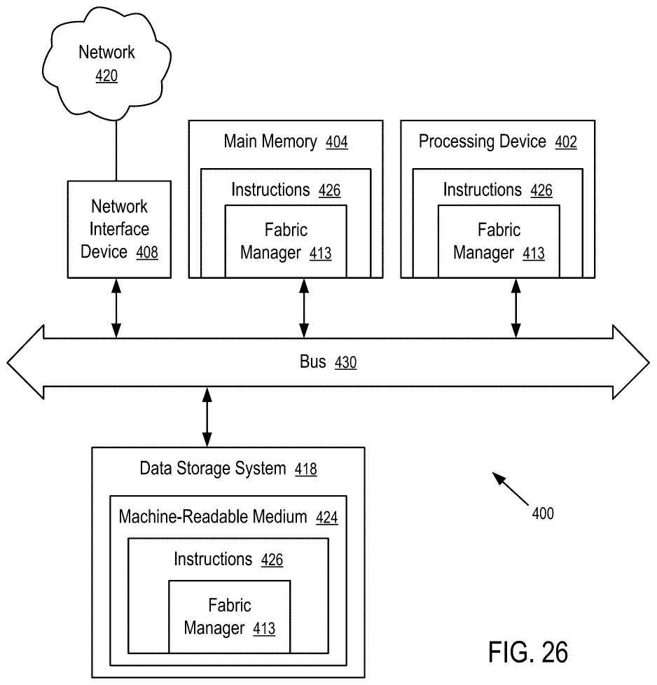

FIG. 26 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of the fabric manager 413 (e.g., to execute instructions to perform operations corresponding to the fabric 121 described with reference to FIG. 1-25). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the fabric manager 413 of the fabric 121 described with reference to FIG. 1 - 25. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
receiving, in a computer express link fabric, memory access requests;
routing, by the computer express link fabric, the memory access requests to one or more memory devices connected to the computer express link fabric to generate responses to the memory access requests; and
updating, using a reinforcement learning technique and based on the routing, expected reward values for compressing a portion of data stored in the one or more memory devices using a plurality of compression techniques.

2. The method of claim 1, further comprising:
selecting, based on the expected reward values, a compression technique from the plurality of compression techniques;
performing compression of the portion of the data using the compression technique selected based on the expected reward values;
updating, using the reinforcement learning technique and based on the routing, a plurality of sets of expected reward values for compressing respectively a plurality of portions of the data stored in the one or more memory devices; and
selecting, based on the plurality of sets of expected reward values, the portion of the data for compressing using the compression technique.

3. The method of claim 2, wherein each set of the plurality of sets of expected rewards values includes expected reward values for applying the plurality of compression techniques respectively to one of the plurality of portions of the data.

4. The method of claim 1, wherein the expected reward values include a plurality of subsets corresponding respectively to compressing the portion of the data under a plurality of states of operation; and the method further comprises:
determining a current state of operation;
wherein the selecting is based on the current state of operation and a subset, among the plurality of subsets, corresponding to the current state of operation.

5. The method of claim 4, wherein the current state of operation is based at least in part on:
an age of allocation of random access memory cells to store the portion of the data;
an access frequency of the portion of the data;
a lapsed time since last accessing the portion of the data;
a dominant type of accessing the portion of the data; or
an application context of the portion of the data; or
any combination thereof.

6. The method of claim 5, wherein the expected reward values are determined for the updating without performing compression operations on the portion of the data.

7. The method of claim 6, wherein each expected reward value in each of the plurality of subset is based on determination of:
an amount of reduction in random access memory cells for storing the portion of the data in a compressed form according to one of the plurality of compression techniques; and
a time gap between completion of compression of the portion of the data and a subsequent request to access the portion of the data.

8. The method of claim 5, wherein in updating each respective reward value corresponding to applying, under a state of operation, a first compression technique among the plurality of compression techniques, the method comprises:
determining a compression ratio of applying the first compression technique to the portion of the data;
determining an amount of reduction in random access memory cells for storing the portion of the data in a compressed form based on the compression ratio;
determining a first time instance of completion of compressing the portion of the data;
identifying a second time instance of an incoming memory access request addressing the portion of the data;
determining a length of a time gap between the first time instance and the second time instance; and
computing a reward value as a function of the length of the time gap and the amount of reduction.

9. The method of claim 8, wherein the compression ratio and the first time instance are estimated based on compressing a random sample from the portion of the data.

10. The method of claim 8, wherein the compression ratio and the first time instance are estimated based on a classification of the portion of the data.

11. A computer express link switch, comprising:
a plurality of ports; and
a circuit configured to:
update, using a reinforcement learning technique and based on routing memory access requests to the ports, expected reward values for compressing a portion of data stored in a memory device using a plurality of compression techniques.

12. The computer express link switch of claim 11, wherein the circuit is further configured to:
select, based on the expected reward values, a compression technique from the plurality of compression techniques;
perform compression of the portion of the data using the compression technique selected based on the expected reward values;
identify the memory device based on the memory device being connected to one of the plurality of ports via a computer express link connection without an intervening switch; and
allocate random access memory cells from the memory device to store the portion of the data.

13. The computer express link switch of claim 12, wherein reinforcement learning technique is a Q-learning technique; and the expected reward values are updated for a state of operation among a plurality of states of operation.

14. The computer express link switch of claim 13, wherein the circuit is further configured to determine the state of operation based on:
an age of allocation of the random access memory cells to store the portion of the data;
an access frequency of the portion of the data;
a lapsed time since last accessing the portion of the data;
a dominant type of accessing the portion of the data; or
an application context of the portion of the data; or
any combination thereof.

15. The computer express link switch of claim 14, wherein to update a respective expected reward value among the expected reward values, the circuit is configured to determine an average latency of responses to memory access requests routed through the computer express link switch during a time period of a predetermined interval following a first operation selected to compress the portion of the data using a compression technique among the plurality of compression techniques.

16. The computer express link switch of claim 15, wherein the first operation is further configured to offload a compressed version of the portion of the data to outside of the memory device and to allocate the random access memory cells for memory addresses different from memory addresses of the portion of the data.

17. The computer express link switch of claim 14, wherein to update a respective expected reward value among the expected reward values, the circuit is configured to determine an amount of rewards for performing compression of the portion of the data using a first compression technique among the plurality of compression techniques; and
the amount of rewards is a function of:
an amount of random access memory cells to be freed after applying the first compression technique to the portion of the data; and
a time gap between completion of applying, responsive to the state of operation, the first compression technique to the portion of the data and a subsequent request to access the portion of the data.

18. A non-volatile computer readable medium storing instructions which when executed in a computer express link switch, cause the computer express link switch to perform a method, comprising:
updating, using a reinforcement learning technique and based on routing memory access requests to ports of the computer express link switch, expected reward values for compressing using a plurality of compression techniques, a plurality of portions of data stored in one or more memory devices; and
selecting, based on the expected reward values, a compression technique from the plurality of compression techniques and a portion from the plurality of portions.

19. The non-volatile computer readable medium of claim 18, wherein
the method further comprises:
freeing random access memory cells from the one or more memory devices via performing compression of the portion using the compression technique selected based on the expected reward values;
wherein the expected reward values include a plurality of subsets corresponding to a plurality of states of operation; and the selecting comprises:
determining a current state of operation; and
determining, at the current state of operation, a plurality of maximum expected reward values for the plurality of portions respectively, wherein each of the plurality of maximum expected reward values is determined from maximizing rewards for compressing one of the plurality of portions; and
determining a largest one of the plurality of maximum expected reward values to identify the portion and the compression technique.

20. The non-volatile computer readable medium of claim 19, wherein the current state of operation is based on:
an age of allocation of the random access memory cells to store the portion;
an access frequency of the portion;
a lapsed time since last accessing the portion;
a dominant type of accessing the portion; or
an application context of the portion; or
any combination thereof.
